(19) United States
(12) Patent Application Publication
(10) Pub. No.: US 2025/0316750 A1
(43) Pub. Date: Oct. 9, 2025

(54) MODIFIED SULFIDE SOLID ELECTROLYTE, PRODUCTION METHOD FOR SAME, ELECTRODE MIXTURE, AND LITHIUM-ION BATTERY

(71) Applicant: IDEMITSU KOSAN CO.,LTD., Tokyo (JP)

(72) Inventors: Keita SEDA, Chiyoda-ku, Tokyo (JP); Tomoyuki OKUYAMA, Chiyoda-ku, Tokyo (JP); Takamoto MORITA, Chiyoda-ku, Tokyo (JP); Kenji MORIYAMA, Chiyoda-ku, Tokyo (JP)

(73) Assignee: IDEMITSU KOSAN CO.,LTD., Tokyo (JP)

(21) Appl. No.: 18/879,331

(22) PCT Filed: Jul. 26, 2023
(86) PCT No.: PCT/JP2023/027339

§ 371 Date: Dec. 27, 2024

(30) Foreign Application Priority Data
Jul. 27, 2022 (JP) 2022-119683

(51) Int. Cl. H01M 10/056; H01M 10/0525

(52) U.S. Cl. CPC H01M 10/056; H01M 10/0525; H01M 2300/0091

(57) ABSTRACT

Provided are a modified sulfide solid electrolyte containing a sulfide solid electrolyte having a BET specific surface area of 10 m²/g or more and containing a lithium atom, a sulfur atom, a phosphorus atom, and a halogen atom, and at least one compound selected from the particular compounds (1) to (6) that is excellent in coating suitability in coating as a paste, and can exhibit the excellent battery capabilities efficiently, irrespective of the large specific surface area of the sulfide solid electrolyte, and a method of producing the same, and also an electrode mixture and a lithium ion battery using the same.

### TECHNICAL FIELD

The present invention relates to a modified sulfide solid electrolyte and a method of producing the same, and an electrode mixture and a lithium ion battery.

### BACKGROUND ART

With rapid spread in recent years of information-related devices, communication devices, and the like, such as personal computers, video cameras, and mobile phones, development of batteries that are utilized as a power source therefor is considered to be important. In particular, lithium ion batteries are attracting attention from the standpoint of the high energy density thereof.

The batteries used in these applications have used an electrolytic solution containing a flammable organic solvent, which thus requires a safety equipment provided for suppressing temperature rise in short circuit, a structure preventing short circuit, and improvements in materials. In view of the situations, the use of a solid electrolyte instead of the electrolytic solution making the battery fully solid can avoid the use of a flammable organic solvent, can simplify the safety equipment, and can improve the production cost and the productivity, and therefore a battery using a solid electrolyte layer instead of the electrolytic solution is being developed.

A sulfide solid electrolyte has been known as a solid electrolyte used in a solid electrolyte layer, and the sulfide solid electrolyte is firstly being demanded to enhance the ionic conductivity, and also to enhance the battery capabilities in the use thereof in a lithium ion battery. Examples of measures being investigated for enhancing the capabilities include a technique of covering the surface of the electrolyte, and a technique using a composition containing a solid electrolyte and an organic compound.

For example, PTL 1 proposes a production method of a composite solid electrolyte including a sulfide based solid electrolyte, the surface of which is covered with a prescribed halogenated hydrocarbon compound as a coating material for enhancing the ionic conductivity. PTL 2 describes a solid electrolyte composition including a sulfide solid electrolyte having on the surface thereof a coating film formed with a compound having a C═O bond and a compound having an S═O bond, for enhancing the cycle characteristics of a lithium ion battery by enhancing the affinity of the solid electrolyte with an active substance used in a negative electrode, a positive electrode, and the like in producing the lithium ion battery. PTL 3 describes a solid electrolyte composition containing a dispersion medium, such as a ketone compound and an alcohol compound, as a solid electrolyte composition capable of producing a fully solid secondary battery showing an excellent battery capacity.

For example, furthermore, PTL 4 describes a solid electrolyte composition containing a fluorine-containing compound containing a fluorine atom and P—O or C—O for achieving good cycle characteristics. PTL 5 describes a technique using a solid electrolyte composition containing a solid electrolyte layer containing an inorganic solid electrolyte and an organic compound having a nonionic monovalent halogen atom other than fluorine, for achieving a fully solid secondary battery that suppresses the growth of lithium dendrite, unlikely causes short circuit, and can suppress the decrease in battery voltage to a high level.

For example, furthermore, PTL 6 describes that in a sulfide solid electrolyte containing a lithium element, a phosphorus element, and a sulfur element, also containing an ester compound of a carboxylic acid and an alcohol, the ester compound is bonded or adsorbed to the surface of the conductive sulfide, enabling the enhancement of the cycle characteristics of a solid battery, and the sulfide solid electrolyte can be obtained by the production method including a step of wet-pulverizing a slurry containing a lithium ion conductive sulfide, an organic solvent, and an ester compound. PTL 7 describes a technique of enhancing the ionic conductivity by covering a sulfide solid electrolyte with a prescribed organic compound having a halogen element as a functional group as a coating agent, and PTL 8 describes a technique of enhancing the ionic conductivity and the moldability by containing a phosphorus compound, such as a phosphate ester.

As described above, for contributing to the practical utilization of lithium ion batteries in recent years, there are diversified demands including not only the simple enhancement of the ionic conductivity of the sulfide solid electrolyte, but also the enhancement of other capabilities, such as the capability of the solid electrolyte in applying the solid electrolyte to lithium ion batteries. For addressing the demands, the current situation is that the technique of covering the surface of a solid electrolyte, the technique of forming a composition containing a solid electrolyte and an organic compound, and the like are being investigated.

### CITATION LIST

### Patent Literatures

PTL 1: JP 2020-87633 A
PTL 2: JP 2017-147173 A
PTL 3: WO 2019/151373
PTL 4: JP 2017-157300 A
PTL 5: JP 2019-067523 A
PTL 6: WO 2020/203231
PTL 7: JP 2020-087633 A
PTL 8: JP 2020-166994 A

### SUMMARY OF INVENTION

### Technical Problem

The present invention has been made in view of the current situation, and an object thereof is to provide a modified sulfide solid electrolyte that is excellent in coating suitability in coating as a paste, and is capable of exerting excellent battery capabilities efficiently, and a method of producing the same, and also to provide an electrode mixture and a lithium ion battery that exert excellent battery capabilities.

### Solution to Problem

A modified sulfide solid electrolyte according to the present invention is a modified sulfide solid electrolyte containing a sulfide solid electrolyte having a BET specific surface area of 10 m²/g or more and containing a lithium atom, a sulfur atom, a phosphorus atom, and a halogen atom, and at least one compound selected from the following compounds (1) to (6):
compound (1): a compound having a formyl group (CH(═O)—),
compound (2): a compound having one or more acetyl group (CH₃C(═O)—),
compound (3): a compound having two or more halogen-containing groups represented by —CH₂X (in which X represents a fluorine atom or a bromine atom) and an organic group,
compound (4): a thiol compound,
compound (5): a metal-free phosphorus compound (provided that the compound does not contain an oxygen atom that is bonded to a phosphorus atom via a single bond), and
compound (6): a metal-free boron compound.

A method of producing a modified sulfide solid electrolyte according to the present invention is
a method of producing a modified sulfide solid electrolyte, including
mixing a sulfide solid electrolyte having a BET specific surface area of 10 m²/g or more and containing a lithium atom, a sulfur atom, a phosphorus atom, and a halogen atom, at least one compound selected from the following compounds (1) to (6), and an organic solvent, and
removing the organic solvent:
compound (1): a compound having a formyl group (CH(═O)—),
compound (2): a compound having one or more acetyl group (CH₃C(═O)—),
compound (3): a compound having two or more halogen-containing groups represented by —CH₂X (in which X represents a fluorine atom or a bromine atom) and an organic group,
compound (4): a thiol compound,
compound (5): a metal-free phosphorus compound (provided that the compound does not contain an oxygen atom that is bonded to a phosphorus atom via a single bond), and
compound (6): a metal-free boron compound.

An electrode mixture according to the present invention is
an electrode mixture containing the modified sulfide solid electrolyte according to the present invention, and an electrode active substance.

A lithium ion battery according to the present invention is
a lithium ion battery including at least one of the modified sulfide solid electrolyte according to the present invention and the electrode mixture according to the present invention.

### Advantageous Effects of Invention

The present invention can provide a modified sulfide solid electrolyte that is excellent in coating suitability in coating as a paste, and is capable of exerting excellent battery capabilities efficiently, and a method of producing the same, and also can provide an electrode mixture that exerts excellent battery capabilities and a lithium ion battery.

### DESCRIPTION OF EMBODIMENTS

An embodiment of the present invention (which may be hereinafter referred to as a “present embodiment”) is described below. In the description herein, the numerical values for the upper limit and the lower limit of the numerical ranges described with “or more”, “or less”, and “to” are numerical values that can be optionally combined, and the numerical values in the examples can be used as a numerical value for the upper limit and the lower limit.

### Knowledge Obtained by Present Inventors in Achieving Present Invention

As a result of earnest investigations for solving the problem by the present inventors, the following matters have been found, and the present invention has been completed.

A technique of allowing a certain compound to cover a surface of a sulfide solid electrolyte or to be contained therein has existed as shown in PTLs 1 to 8. PTLs 1 to 8 use the technique, and thereby intend to enhance the battery capabilities, for example, enhancing the ionic conductivity, and enhancing the cycle characteristics of a lithium ion battery by enhancing the affinity of the solid electrolyte with an active substance used in a negative electrode, a positive electrode, and the like in producing the lithium ion battery.

In the production process of a lithium ion battery (which may be referred to as a “fully solid battery”), a paste is prepared by mixing a solid electrolyte, other prescribed components, and a solvent, and the paste is coated to form a separator layer and an electrode mixture layer. The enhancement of the capabilities of these layers requires the enhancement of the density of the solid electrolyte constituting the layers, and the use of a solid electrolyte having a large specific surface area is effective for enhancing the density.

While there is a demand for using a solid electrolyte having a large specific surface area, a problem exists in production that the solid electrolyte having a large specific surface area increases the viscosity of the paste, which significantly deteriorates the coating suitability. On the other hand, the coating suitability of the paste can be improved by reducing the viscosity of the paste by using a large amount of a solvent, which however leads to a problem of prolonging the drying time, and a problem of deterioration in battery capabilities due to the reduction of the density of the solid electrolyte constituting the layers. Accordingly, there is a trade-off relationship between the coating suitability of the paste and the high battery capabilities. A sulfide solid electrolyte having a specific surface area that is as large as 10 m²/g or more not only increases the viscosity of the paste thereof, deteriorating the coating suitability, but also requires a large amount of a solvent for reducing the viscosity of the paste, resulting in the significant deterioration of the battery capabilities due to the prolongation of the drying time and the decrease of the density, as described above.

Various studies have been made for the measures for enhancing the ionic conductivity and the battery capabilities as shown in PTLs 1 to 8. However, under the current situation where the practical use of lithium ion batteries is progressing rapidly, it has been noted that there has been no study on a measure for enhancing the capabilities in the production process, such as the coating suitability of the paste, in focusing on the mass production.

The present inventors have considered the technique of allowing a certain compound to cover the surface of the solid electrolyte as described in PTLs 1 to 8, and have made earnest investigations focusing on the compound covering the surface, and it has been found that even a sulfide solid electrolyte having a large specific surface area of 10 m²/g or more can be a sulfide solid electrolyte that is excellent in coating suitability in coating in the form of paste and is capable of exerting excellent battery capabilities efficiently, by attaching the prescribed compound to the surface thereof. The fact that the effect of providing the excellent coating suitability in coating, as a paste, even a sulfide solid electrolyte having a large specific surface area of 10 m²/g or more by attaching the prescribed compound used in the present invention to the surface of the sulfide solid electrolyte can be obtained is a surprising effect that has not been recognized before.

In the description herein, the “solid electrolyte” means an electrolyte that retains a solid state at 25° C. under a nitrogen atmosphere. The “sulfide solid electrolyte” obtained by the production method of the present embodiment is a solid electrolyte that contains a lithium atom, a sulfur atom, a phosphorus atom, and a halogen atom, and has an ionic conductivity derived from the lithium atom.

The “sulfide solid electrolyte” encompasses both of a crystalline sulfide solid electrolyte having a crystal structure and an amorphous sulfide solid electrolyte. In the description herein, the crystalline sulfide solid electrolyte is a solid electrolyte that has a peak derived from a solid electrolyte observed in an X-ray diffraction pattern in a powder X-ray diffraction (XRD) measurement, irrespective of the presence or absence of a peak derived from the raw materials of the solid electrolyte therein. In other words, the crystalline solid electrolyte contains a crystal structure derived from a solid electrolyte, and a part thereof may have a crystal structure derived from the solid electrolyte or the whole thereof may have a crystal structure derived from the solid electrolyte. The crystalline sulfide solid electrolyte may contain an amorphous sulfide solid electrolyte (which may also be referred to as a “glass component”) as a part thereof, as long as having the X-ray diffraction pattern as described above. Accordingly, the crystalline sulfide solid electrolyte encompasses so-called glass ceramics, which are obtained by heating an amorphous solid electrolyte (glass component) to the crystallization temperature or higher.

In the description herein, the amorphous sulfide solid electrolyte (glass component) means a material having an X-ray diffraction pattern in an X-ray diffraction (XRD) measurement that is a halo pattern having substantially no peak other than the peaks derived from the materials, irrespective of the presence or absence of a peak derived from the raw materials of the solid electrolyte therein.

The distinction between crystallinity and amorphousity described above is applied to both of a sulfide solid electrolyte and a modified sulfide solid electrolyte in the present embodiment.

### EMBODIMENTS OF PRESENT EMBODIMENT

The modified sulfide solid electrolyte according to a first embodiment of the present embodiment is
a modified sulfide solid electrolyte containing a sulfide solid electrolyte having a BET specific surface area of 10 m²/g or more and containing a lithium atom, a sulfur atom, a phosphorus atom, and a halogen atom, and at least one compound selected from the following compounds (1) to (6).
Compound (1): a compound having a formyl group (CH(═O)—)
Compound (2): a compound having one or more acetyl group (CH₃C(═O)—)
Compound (3): a compound having two or more halogen-containing groups represented by —CH₂X (in which X represents a fluorine atom or a bromine atom) and an organic group
Compound (4): a thiol compound
Compound (5): a metal-free phosphorus compound (provided that the compound does not contain an oxygen atom that is bonded to a phosphorus atom via a single bond)
Compound (6): a metal-free boron compound

Typical examples of the sulfide solid electrolyte containing a lithium atom, a sulfur atom, a phosphorus atom, and a halogen atom include a sulfide solid electrolyte obtained by using lithium sulfide, diphosphorus pentasulfide, a lithium halide, an elemental halogen, and the like as raw materials. That is, the modified sulfide solid electrolyte of the present embodiment contains a sulfide solid electrolyte having a large BET specific surface area of 10 m²/g or more, and the compounds (1) to (6) as the particular compound.

A paste containing an ordinary sulfide solid electrolyte having a large BET specific surface area of 10 m²/g or more in a content that is required for securing the density of the solid electrolyte in the layer for exerting the prescribed battery capabilities has a significantly deteriorated coating capability, and it has been extremely difficult to form a positive electrode, a negative electrode, and an electrolyte layer efficiently. The sulfide solid electrolyte of the present embodiment has a significantly enhanced coating suitability by containing the ordinary sulfide solid electrolyte and the compounds (1) to (6) as the particular compound, and in other words, should be referred to as a “modified sulfide solid electrolyte” due to the “modification”.

The particular compounds (1) to (6) used in the modified sulfide solid electrolyte of the present embodiment are common in that the compounds contain a hetero atom, such as an oxygen atom, a halogen atom, a sulfur atom, a phosphorus atom, and a boron atom. The modified sulfide solid electrolyte of the present embodiment necessarily contains the particular compounds (1) to (6) having the particular configuration among compounds containing a hetero atom. The use of the compound exhibits the effect of providing the excellent coating suitability in coating as a paste, and exerting the excellent battery capabilities efficiently.

Although it is unclear how the compounds (1) to (6) are contained in the modified sulfide solid electrolyte of the present embodiment, it is estimated that these compounds are attached to the surface of the sulfide solid electrolyte while retaining the structures thereof.

It has been confirmed from the examples that the sulfide solid electrolyte containing the compounds (1) to (6) has a lower oil absorption than a sulfide solid electrolyte that does not contain the compounds (1) to (6). It is naturally considered that the reduction in oil absorption is derived from the compounds (1) to (6) that are attached to the surface of the sulfide solid electrolyte, and clog at least a part of fine pores that the sulfide solid electrolyte has. It has been known in general that the enhancement of the coating suitability relates to the oil absorption, as similar to the specific surface area. It is estimated that the attachment of compounds (1) to (6) on the surface of the sulfide solid electrolyte reduces the oil absorption and enhances the coating suitability.

The details of the mode of the attachment of the compounds (1) to (6) on the surface of the sulfide solid electrolyte, i.e., either physical attachment or chemical attachment, are unclear. In consideration of the nature of the hetero atom, such as an oxygen atom, having a property of easily bonding to a lithium atom, a halogen atom, and the like, it is highly possible that the hetero atom contained in the compounds (1) to (6) is bonded to the lithium atom, the halogen atom, and the like constituting the sulfide solid electrolyte, and attached to the surface thereof, i.e., the chemical attachment, but in consideration of the estimations described above, it is considered that the oil absorption is reduced to enhance the coating suitability by either the chemical attachment or the physical attachment.

It is considered that the modified sulfide solid electrolyte of the present embodiment can easily reduce the oil absorption, and as a result can enhance the coating suitability, resulting in the enhancement of the battery capabilities, as long as containing the compounds (1) to (6) that are attached to the surface thereof through either of the attachment modes.

The modified sulfide solid electrolyte according to a second embodiment of the present embodiment is the first embodiment, in which the compound (1) is a compound represented by the following general formula (1).

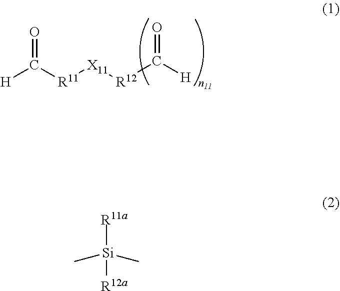

In the general formula (1), R¹¹ and R¹² each independently represent an organic group or a single bond, X₁₁ represents an oxygen atom, a sulfur atom, a group represented by the general formula (1a), or a single bond, and nu represents 0 or 1. In the general formula (1a), R^{11a} and R^{12a} each independently represent an organic group.

As described above, the modified sulfide solid electrolyte of the present embodiment can use the compounds (1) to (6) with no particular limitation, i.e., can have the excellent coating suitability. The compound (1) is a compound having a formyl group (CH(═O)—), and can also be comprehended as a compound having a formyl group at at least one end of the compound. In the compound of this type, the compound (1) used may be a compound having one or two formyl groups (CH(═O)—) represented by the general formula (1), and thereby the oil absorption is reduced, the excellent coating suitability can be easily obtained, and the excellent battery capabilities can be obtained more efficiently.

It is considered that the attachment of the compound (1) is preferably moderate attachment since the moderate attachment enhances the coating suitability through the reduction effect of the oil absorption, resulting in the enhancement of the battery capabilities, and on the other hand, suppresses the decrease of the ionic conductivity, and suppresses the decrease of the enhancing effect of the battery capabilities by the enhancement of the coating suitability. For these effects, the compound (1) is preferably the compound having the particular structure represented by the general formulae (1) since it is considered that the moderate steric hindrance provides the moderate chemical or physical attachment state.

The modified sulfide solid electrolyte according to a third embodiment of the present embodiment is the first or second embodiment, in which the compound (2) is a compound represented by the following general formula (2).

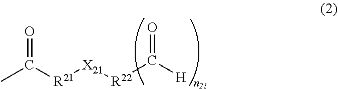

In the general formula (2), R²¹ and R²² each independently represent an organic group or a single bond, X₂₁ represents an oxygen atom, a sulfur atom, or a single bond, and n₂₁ represents 0 or 1.

The compound (2) is a compound having one or more acetyl group (CH₃C(═O)—), and can also be comprehended as a compound having an acetyl group at at least one end of the compound. In the compound of this type, the compound (2) used may be a compound having an acetyl group at at least one end represented by the general formula (2), and thereby the oil absorption is reduced, the excellent coating suitability can be easily obtained, and the excellent battery capabilities can be obtained more efficiently.

In the case where the compound having the particular structure represented by the general formula (2) is used as the compound (2), it is considered that the moderate steric hindrance thereof provides the moderate chemical or physical attachment state, as described for the compound (1) above. Consequently, the oil absorption is reduced, the excellent coating suitability can be easily obtained, and the excellent battery capabilities can be obtained more efficiently.

The modified sulfide solid electrolyte according to a fourth embodiment of the present embodiment is any one of the first to third embodiments, in which the compound (3) is a compound represented by the following general formula (3).

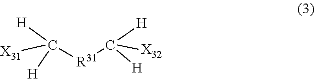

In the general formula (3), R³¹ represents an organic group or a single bond, and X₃₁ and X₃₂ each independently represent a fluorine atom or a bromine atom.

The compound (3) is a compound having two or more halogen-containing groups represented by —CH₂X (in which X represents a fluorine atom or a bromine atom) and an organic group, and can also be comprehended as a compound having halogen-containing groups represented by —CH₂X (in which X represents a fluorine atom or a bromine atom) at at least two ends of an organic group. In the compound of this type, the compound (3) used may be a compound having halogen-containing groups at both ends represented by the general formula (3), and thereby the oil absorption is reduced, the excellent coating suitability can be easily obtained, and the excellent battery capabilities can be obtained more efficiently.

In the case where the compound having the particular structure represented by the general formula (3) is used as the compound (3), it is considered that the moderate steric hindrance thereof provides the moderate chemical or physical attachment state, as described for the compound (1) above. Consequently, the oil absorption is reduced, the excellent coating suitability can be easily obtained, and the excellent battery capabilities can be obtained more efficiently.

The modified sulfide solid electrolyte according to a fifth embodiment of the present embodiment is any one of the first to fourth embodiments, in which the compound (4) is at least one kind of a compound selected from a compound represented by the following general formula (4-1) and a compound represented by the following general formula (4-2).

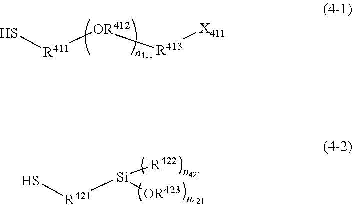

In the general formula (4-1), R⁴¹¹, R⁴¹², and R⁴¹³ each independently represent an organic group or a single bond, X₄₁₁ represents a hydrogen atom or a thiol group, and n₄₁₁ represents an integer of 0 to 3, provided that at least one of R⁴¹¹, R⁴¹², and R⁴¹³ represents an organic group. In the general formula (4-2), R⁴²¹, R⁴²², and R⁴²³ each independently represent an organic group, n₄₂₁ and n₄₂₂ each represent an integer of 0 to 3, in which n₄₂₁ and n₄₂₂ satisfy n₄₂₁+n₄₂₂=3.

The compound (4) is a thiol compound, i.e., a compound having a thiol group, and with the use of a compound having a thiol group at at least one end (i.e., a compound having a thiol group at one end or both ends) represented by the general formula (4), the oil absorption is reduced, the excellent coating suitability can be easily obtained, and the excellent battery capabilities can be obtained more efficiently.

In the case where the compound having the particular structure represented by the general formula (4) is used as the compound (4), it is considered that the moderate steric hindrance thereof provides the moderate chemical or physical attachment state, as described for the compound (1) above. Consequently, the oil absorption is reduced, the excellent coating suitability can be easily obtained, and the excellent battery capabilities can be obtained more efficiently.

The modified sulfide solid electrolyte according to a sixth embodiment of the present embodiment is any one of the first to fifth embodiments, in which the compound (5) is at least one kind of a compound selected from a compound represented by the following general formula (5-1), a compound represented by the following general formula (5-2), and a compound represented by the following general formula (5-3).

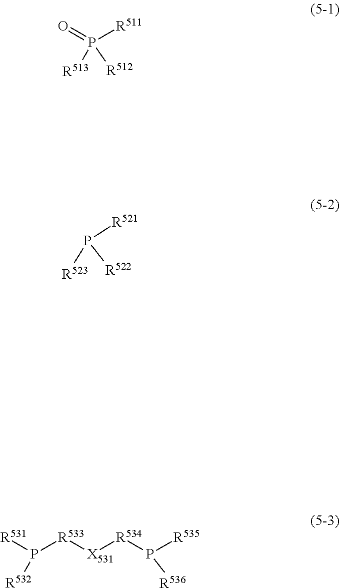

In the general formula (5-1), R⁵¹¹, R⁵¹², and R⁵¹³ each independently represent an organic group. In the general formula (5-2), R⁵²¹, R⁵²², and R⁵²³ each independently represent an organic group. In the general formula (5-3), R⁵³¹, R⁵³², R⁵³⁵, and R⁵³⁶ each independently represent an organic group, R⁵³³ and R⁵³⁴ each independently represent a single bond or an organic group, and X₅₃₁ represents a single bond or an oxygen atom, in which at least one of R⁵³³ and R⁵³⁴ represents an organic group, and R⁵³³ and R⁵³⁴ may be bonded to each other to form a condensed ring.

The compound (5) is a metal-free phosphorus compound (provided that the compound does not contain an oxygen atom that is bonded to a phosphorus atom via a single bond), and with the use of a metal-free phosphorus compound represented by the general formulae (5-1), (5-2), and (5-3), the oil absorption is reduced, the excellent coating suitability can be easily obtained, and the excellent battery capabilities can be obtained more efficiently.

In the case where the compound having the particular structure represented by the general formulae (5-1), (5-2), and (5-3) is used as the compound (5), it is considered that the moderate steric hindrance thereof provides the moderate chemical or physical attachment state, as described for the compound (1) above. Consequently, the oil absorption is reduced, the excellent coating suitability can be easily obtained, and the excellent battery capabilities can be obtained more efficiently.

The modified sulfide solid electrolyte according to a seventh embodiment of the present embodiment is any one of the first to sixth embodiments, in which the compound (5) has a molecular weight of 3,000 or less.

In the case where the molecular weight of the compound (5) is 3,000 or less, the oil absorption is reduced, the excellent coating suitability can be easily obtained, and the excellent battery capabilities can be obtained more efficiently.

The modified sulfide solid electrolyte according to an eighth embodiment of the present embodiment is any one of the first to seventh embodiments, in which the compound (6) is a compound represented by the following general formula (6).

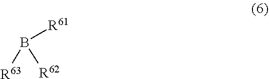

In the general formula (6), R⁶¹, R⁶², and R⁶³ each independently represent an organic group.

The compound (6) is a metal-free boron compound, and with the use of a metal-free boron compound represented by the general formula (6), the oil absorption is reduced, the excellent coating suitability can be easily obtained, and the excellent battery capabilities can be obtained more efficiently.

In the case where the compound having the particular structure represented by the general formula (6) is used as the compound (6), it is considered that the moderate steric hindrance thereof provides the moderate chemical or physical attachment state, as described for the compound (1) above. Consequently, the oil absorption is reduced, the excellent coating suitability can be easily obtained, and the excellent battery capabilities can be obtained more efficiently.

The modified sulfide solid electrolyte according to a ninth embodiment of the present embodiment is any one of the first to eighth embodiments, in which the modified sulfide solid electrolyte has a content of the compound of 0.03 part by mass or more and 25 parts by mass or less per 100 parts by mass of the sulfide solid electrolyte.

In the case where the content of compounds (1) to (6) is 0.03 part by mass or more and 25 parts by mass or less per 100 parts by mass of the sulfide solid electrolyte, the compounds are moderately dispersed and attached to the surface of the sulfide solid electrolyte to reduce the oil absorption and to retain the proper ionic conductivity, and thereby the coating suitability can be easily enhanced, and the excellent battery capabilities can be obtained efficiently. As for the content of the compounds, in case that the amount of the compounds used in producing the modified sulfide solid electrolyte is known, the amount can be used as the content of the compounds.

A method of producing a modified sulfide solid electrolyte according to a tenth embodiment of the present embodiment includes mixing a sulfide solid electrolyte having a BET specific surface area of 10 m²/g or more and containing a lithium atom, a sulfur atom, a phosphorus atom, and a halogen atom, at least one compound selected from the following compounds (1) to (6), and an organic solvent, and removing the organic solvent:
compound (1): a compound having a formyl group (CH(═O)—),
compound (2): a compound having one or more acetyl group (CH₃C(═O)—),
compound (3): a compound having two or more halogen-containing groups represented by —CH₂X (in which X represents a fluorine atom or a bromine atom) and an organic group,
compound (4): a thiol compound,
compound (5): a metal-free phosphorus compound (provided that the compound does not contain an oxygen atom that is bonded to a phosphorus atom via a single bond), and
compound (6): a metal-free boron compound.

The production method of the modified sulfide solid electrolyte of the present embodiment is not particularly limited, as far as containing the compounds (1) to (6) as described above, and according to the method of producing a modified sulfide solid electrolyte according to the tenth embodiment of the present embodiment, the compounds (1) to (6) can exist to attach to the surface of the sulfide solid electrolyte in view of the features thereof, and thereby the modified sulfide solid electrolyte is excellent in coating suitability and exerts the excellent battery capabilities efficiently, and the modified sulfide solid electrolyte of the present embodiment can be produced more efficiently.

While a mixture in the form of solution or slurry is obtained by mixing the sulfide solid electrolyte, the compounds (1) to (6), and the solvent, the modified sulfide solid electrolyte cannot be used as it is, and therefore the removal of the organic solvent from the solution or slurry is included.

The method of producing a modified sulfide solid electrolyte according to an eleventh embodiment of the present embodiment is the production method according to the tenth embodiment, in which the organic solvent used therein is at least one kind of a solvent selected from an aliphatic hydrocarbon solvent, an alicyclic hydrocarbon solvent, an aromatic hydrocarbon solvent, an ether solvent, an ester solvent, and a nitrile solvent.

The use of the solvents above as the organic solvent can facilitate the attachment of the compounds (1) to (6) to the surface of the sulfide solid electrolyte, and can easily enhance the coating suitability.

An electrode mixture according to a twelfth embodiment of the present embodiment contains the modified sulfide solid electrolyte according to any one of the first to ninth embodiments and an electrode active substance.

A lithium ion battery according to a thirteenth embodiment of the present embodiment includes at least one of the modified sulfide solid electrolyte according to any one of the first to ninth embodiments and the electrode active substance according to the twelfth embodiment.

As described above, the modified sulfide solid electrolyte of the present embodiment is excellent in coating suitability in coating as a paste, and can exert the excellent battery capabilities efficiently. Accordingly, the electrode mixture containing the modified sulfide solid electrolyte of the present embodiment is also excellent in coating suitability, and can produce a lithium ion battery efficiently, and the resulting lithium ion battery has the excellent battery capabilities.

### [Modified Sulfide Solid Electrolyte]

The modified sulfide solid electrolyte of the present embodiment contains a sulfide solid electrolyte having a BET specific surface area of 10 m²/g or more and containing a lithium atom, a sulfur atom, a phosphorus atom, and a halogen atom, and at least one compound selected from the following compounds (1) to (6):
compound (1): a compound having a formyl group (CH(═O)—),
compound (2): a compound having one or more acetyl group (CH₃C(═O)—),
compound (3): a compound having two or more halogen-containing groups represented by —CH₂X (in which X represents a fluorine atom or a bromine atom) and an organic group,
compound (4): a thiol compound,
compound (5): a metal-free phosphorus compound (provided that the compound does not contain an oxygen atom that is bonded to a phosphorus atom via a single bond), and
compound (6): a metal-free boron compound.

The compounds (1) to (6) contained in the modified sulfide solid electrolyte of the present embodiment will be described below.

### (Compound (1))

The compound (1) used in the modified sulfide solid electrolyte of the present embodiment is a compound having a formyl group (CH(═O)—). Preferred examples of the compound (1) include a compound represented by the following general formula (1), and thereby the oil absorption is reduced, the excellent coating suitability can be easily obtained, and the excellent battery capabilities can be obtained more efficiently.

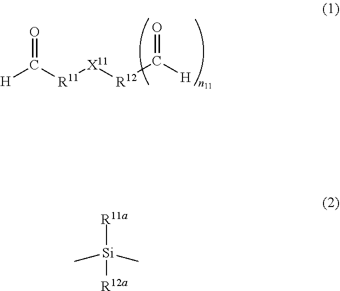

In the general formula (1), R¹¹ and R¹² each independently represent an organic group or a single bond, Xn represents an oxygen atom, a sulfur atom, a group represented by the general formula (1a), or a single bond, and n₁₁ represents 0 or 1. In the general formula (1a), R^{11a} and R^{12a} each independently represent an organic group.

The organic group represented by R¹¹ is a divalent group, and the organic group represented by R¹² is a monovalent group in the case where nu represents 0, or a divalent group in the case where nu represents 1. Examples of the organic group represented by R¹¹ and R¹² include an aliphatic group, an alicyclic group, an aromatic group, and a heterocyclic group, in which an aliphatic group and an aromatic group are preferred.

### (Aliphatic Group)

Examples of the monovalent aliphatic group include an alkyl group, an alkenyl group, and an alkynyl group, in which an alkyl group and an alkenyl group are preferred, and an alkyl group is more preferred, from the standpoint of reducing the oil absorption, easily providing the excellent coating suitability, and providing the excellent battery capabilities more efficiently.

From the same standpoint, the number of carbon atoms of the monovalent aliphatic group is preferably 1 or more, more preferably 2 or more, and further preferably 3 or more, and the upper limit thereof is preferably 20 or less, more preferably 16 or less, and further preferably 12 or less.

Typical preferred examples of the monovalent aliphatic group include a methyl group, an ethyl group, various propyl groups, various butyl groups, various pentyl groups, various hexyl groups, various heptyl groups, various octyl groups, various nonyl groups, various decyl groups, various undecyl groups, and various dodecyl groups. In the description herein, the term “various” means that a linear group, a branched group, and isomers thereof are encompassed, and for example, various propyl groups encompasses a 1-propyl group, a 2-propyl group, and a 1-methylethyl group, which are linear and branched saturated aliphatic groups having 3 carbon atoms.

The aliphatic group may be either linear or branched, and is preferably linear.

Examples of the divalent aliphatic group include a group obtained by removing one hydrogen atom to form a bonding site in the monovalent aliphatic group described above, i.e., an alkanediyl group, an alkenediyl group, and an alkynediyl group. An alkanediyl group and an alkenediyl group are preferred, and an alkanediyl group is more preferred, from the standpoint of reducing the oil absorption, easily providing the excellent coating suitability, and providing the excellent battery capabilities more efficiently.

The number of carbon atoms of the divalent aliphatic group is preferably 1 or more, and the upper limit thereof is preferably 12 or less, more preferably 8 or less, further preferably 4 or less, and still further preferably 3 or less. The other matters therefor are the same as in the monovalent aliphatic group described above.

The aliphatic group may be a group in which at least a part of the hydrogen atoms thereof is replaced by a halogen atom, a hydroxy group, an amino group, or the like.

### (Alicyclic Group)

Examples of the monovalent alicyclic group include a cycloalkyl group, a cycloalkenyl group, and a cycloalkynyl group, in which a cycloalkyl group and a cycloalkenyl group are preferred, and a cycloalkyl group is more preferred, from the standpoint of reducing the oil absorption, easily providing the excellent coating suitability, and providing the excellent battery capabilities more efficiently.

From the same standpoint, the number of carbon atoms of the monovalent alicyclic group is preferably 3 or more, and more preferably 4 or more, and the upper limit thereof is preferably 20 or less, more preferably 16 or less, and further preferably 12 or less.

Typical preferred examples of the alicyclic group include a group containing multiple alicyclic rings, and preferred examples thereof include a group obtained by removing one hydrogen atom to form a bonding site from a basic structure, for example, a structure containing multiple alicyclic rings, and preferred examples thereof include a bonded polyaliphatic ring structure, such as bicyclohexyl; a structure containing two or more alicyclic rings condensed to each other, such as hexahydronaphthalene, octahydronaphthalene, and decahydronaphthalene; and a bridged cyclic structure, such as norbornane, norbornene, adamantane, tricyclodecane, and pinene. Examples of the basic structure also include a basic structure having a double bond in the alicyclic ring, such as pentalene and azulene.

Preferred examples of the basic structure also include a structure containing any of the basic structure of the monocyclic alicyclic ring, the basic structure of the polycyclic alicyclic rings, and the basic structure of the aromatic ring described later, which are bonded or condensed to each other.

As for the one hydrogen atom to be removed from the basic structure of the alicyclic group, the one hydrogen atom may be a hydrogen atom of the alicyclic ring, and may be a hydrogen atom of a substituent, such as an alkyl group, bonded to the alicyclic ring (the substituent is described later).

The basic structure of the alicyclic group may have a heterocyclic ring obtained by replacing the carbon atom of the alicyclic group described above by a hetero atom, such as a nitrogen atom, an oxygen atom, a sulfur atom, and a phosphorus atom.

The examples of the basic structure of the alicyclic group are merely typical preferred examples thereof, and the basic structure is not limited thereto. For example, examples thereof also include a group containing an alicyclic group based on the basic structure above, having bonded or condensed thereto an aromatic group or a heterocyclic group described later.

In the alicyclic group and the basic structure described above, at least a part of the hydrogen atoms may be replaced by a halogen atom, such as a fluorine atom, a hydroxy group, an amino group, or a substituent, such as the aliphatic group above. In this case, the aliphatic group is preferably an alkyl group or an alkenyl group, the number of carbon atoms of which is preferably 1 or more, and the upper limit thereof is preferably 12 or less, more preferably 8 or less, further preferably 6 or less, and still further preferably 4 or less.

Examples of the divalent alicyclic group include a group obtained by removing one hydrogen atom to form a bonding site from the monovalent alicyclic group described above. The one hydrogen atom may be a hydrogen atom of the alicyclic ring, and may be a hydrogen atom of a substituent, such as an alkyl group, bonded to the alicyclic ring.

### (Aromatic Group)

Preferred examples of the monovalent aromatic group include a group obtained by removing one hydrogen atom to form a bonding site from a basic structure, for example, a monocyclic aromatic compound, such as benzene, toluene, and styrene; a bonded polycyclic aromatic compound containing multiple aromatic rings bonded to each other, such as biphenyl, diphenylmethane (benzylbenzene), diphenylethane (bibenzyl), methylidynetrisphenol, and triphenylcyclohexane; and a condensed polycyclic aromatic compound containing multiple aromatic rings condensed to each other, such as naphthalene, phenanthrene, anthracene, pyrene, triphenylene, tetracene, and pentacene, and that containing an aromatic ring and an alicyclic ring condensed each other, such as indene, indacene, acenaphthene, dihydronaphthalene, tetrahydronaphthalene, biphenylene, fluorene, and fluoranthene.

As for the one hydrogen atom to be removed from the aromatic group, the one hydrogen atom may be a hydrogen atom of the aromatic ring (including the condensed polycyclic ring and the like above), and may be a hydrogen atom of a substituent, such as an alkyl group, bonded to the aromatic ring (including the condensed polycyclic ring and the like above) (the substituent is described later). A group obtained by removing one hydrogen atom of the hydrogen atoms of the substituent, such as an alkyl group, bonded to the aromatic ring (including the condensed polycyclic ring and the like above) from the standpoint of reducing the oil absorption, easily providing the excellent coating suitability, and providing the excellent battery capabilities more efficiently.

Among the above, the aromatic group is preferably an aromatic group having a monocyclic aromatic compound as the basic structure, in which preferred examples thereof include a group obtained by removing one hydrogen atom to form a bonding site from an aromatic ring, such as a phenyl group, a methylphenyl group, and a vinylphenyl group; and a group obtained by removing one hydrogen atom to form a bonding site from an alkyl group bonded to an aromatic ring, such as a benzyl group, a phenylethyl group, and a phenylpropyl group, and more preferred examples thereof include a group obtained by removing one hydrogen atom to form a bonding site from an alkyl group bonded to an aromatic ring, such as a benzyl group, a phenylethyl group, and a phenylpropyl group.

The number of carbon atoms of the monovalent aromatic group is preferably 6 or more, and more preferably 7 or more, and the upper limit thereof is preferably 36 or less, more preferably 24 or less, further preferably 12 or less, and still further preferably 10 or less.

The basic structure of the aromatic group may have a heterocyclic ring obtained by replacing the carbon atom of the aromatic ring (including the condensed polycyclic ring and the like) in the basic structure described above by a hetero atom, such as a nitrogen atom, an oxygen atom, a sulfur atom, and a phosphorus atom.

The examples of the basic structure of the aromatic group are merely typical preferred examples thereof, and the basic structure is not limited thereto. For example, examples thereof also include a group containing an aromatic group based on the basic structure above, having bonded or condensed thereto the aliphatic group described above or a heterocyclic group described later.

In the basic structure described above, at least a part of the hydrogen atoms of the aromatic ring (including the condensed polycyclic ring and the like) may be replaced by a halogen atom, such as a fluorine atom, a hydroxy group, an amino group, or a substituent, such as the aliphatic group above. In this case, the aliphatic group is preferably an alkyl group or an alkenyl group, and more preferably an alkyl group, the number of carbon atoms of which is preferably 1 or more, and the upper limit thereof is preferably 12 or less, more preferably 8 or less, further preferably 6 or less, and still further preferably 4 or less.

In the case where at least a part of the hydrogen atoms of the aromatic ring (including the condensed polycyclic ring and the like) is replaced, the substituent is preferably an aliphatic group, and more preferably an alkyl group.

Examples of the divalent aromatic group include a group obtained by removing one hydrogen atom to form a bonding site from the monovalent aromatic group described above. The one hydrogen atom may be a hydrogen atom of the aromatic ring, and may be a hydrogen atom of a substituent, such as an alkyl group, bonded to the aromatic ring.

### (Heterocyclic Group)

Examples of the monovalent heterocyclic group include a monocyclic heterocyclic group obtained by removing one hydrogen atom to form a bonding site from a basic structure of a monocyclic heterocyclic compound, for example, a saturated or unsaturated monocyclic oxygen-containing heterocyclic compound, such as oxetane, tetrahydrofuran, dihydrofuran, furan, dioxolane, tetrahydropyran, and pyran; a saturated or unsaturated monocyclic nitrogen-containing heterocyclic compound, such as pyrrolidine, pyrroline, imidazolidine, imidazoline, imidazole, piperidine, pyridine, piperazine, pyridazine, pyrimidine, pyrazine, and triazine; a saturated or unsaturated monocyclic sulfur-containing heterocyclic compound, such as thietane, tetrahydrothiophene, thiophene, thiane, and thiopyran; a saturated or unsaturated monocyclic oxygen-nitrogen-containing heterocyclic compound, such as tetrahydrooxazole, oxazole, oxadiazole, succinimide, morpholine, and oxazine; a saturated or unsaturated monocyclic nitrogen-sulfur-containing heterocyclic compound, such as tetrahydrothiazole, thiazole, thiomorpholine, and thiazine; and a saturated or unsaturated monocyclic oxygen-sulfur-containing heterocyclic compound, such as oxathiolane, sulfolane, thioxane, and dioxooxathiane.

Examples thereof also include a polycyclic heterocyclic group obtained by removing one hydrogen atom to form a bonding site from a basic structure of a polycyclic heterocyclic compound, for example, a saturated or unsaturated condensed polycyclic oxygen-containing heterocyclic compound, such as benzofuran, octahydrobenzofuran, benzopyran, benzodioxane, dibenzofuran, xanthene, and dibenzodioxin; a saturated or unsaturated condensed polycyclic nitrogen-containing heterocyclic compound, such as indoline, indole, indolizine, benzimidazole, azaisoindole, decahydroquinoline, quinoline, quinoxaline, carbazole, acridine, phenazine, and azaadamantane; a saturated or unsaturated condensed polycyclic sulfur-containing heterocyclic compound, such as benzothiophene, benzothiopyran, dodecahydrodibenzothiophene, hexahydrodibenzothiophene, and dibenzothiophene; a condensed polycyclic oxygen-nitrogen-containing heterocyclic compound, such as furopyrrole, benzoxazole, benzoxazine, dihydrobenzoxazine, and phenoxazine; a condensed polycyclic nitrogen-sulfur-containing heterocyclic compound, such as benzothiazole, benzothiadiazole, and phenothiazine; and a condensed polycyclic oxygen-sulfur-containing heterocyclic compound, such as phenylthiochromeneone and phenoxathiin.

The number of carbon atoms of the monovalent heterocyclic group is preferably 3 or more, and more preferably 4 or more, and the upper limit thereof is preferably 36 or less, more preferably 24 or less, and further preferably 18 or less.

The examples of the polycyclic heterocyclic compound are described focusing on the condensed polycyclic compound, but are merely typical preferred examples, and for example, it is obvious that a bonded polycyclic heterocyclic compound is also included in the basic structure. A group containing the heterocyclic group described above having bonded or condensed thereto the alicyclic group and the aromatic group described above is also included therein.

As for the one hydrogen atom to be removed from the heterocyclic group, the one hydrogen atom may be a hydrogen atom of the aromatic ring, and may be a hydrogen atom of a substituent, such as an alkyl group, bonded to the heterocyclic ring (the substituent is described later).

In the basic structure described above, at least a part of the hydrogen atoms of the heterocyclic ring may be replaced by a halogen atom, such as a fluorine atom, a hydroxy group, an amino group, or a substituent, such as the aliphatic group above. In this case, the aliphatic group is preferably an alkyl group or an alkenyl group, and more preferably an alkyl group, the number of carbon atoms of which is preferably 1 or more, and the upper limit thereof is preferably 12 or less, more preferably 8 or less, further preferably 6 or less, and still further preferably 4 or less.

Examples of the divalent heterocyclic group include a group obtained by removing one hydrogen atom to form a bonding site from the monovalent heterocyclic group described above. The one hydrogen atom may be a hydrogen atom of the heterocyclic ring, and may be a hydrogen atom of a substituent, such as an alkyl group, bonded to the heterocyclic ring.

X₁₁ represents an oxygen atom, a sulfur atom, a group represented by the general formula (1a), or a single bond. X₁₁ preferably represents an oxygen atom, a group represented by the general formula (1a), or a single bond from the standpoint of reducing the oil absorption, easily providing the excellent coating suitability, and providing the excellent battery capabilities more efficiently.

In the general formula (1a), R^{11a} and R^{12a} each independently represent an organic group. Examples of the organic group represented by R^{11a} and R^{12a} include the aliphatic group, the alicyclic group, the aromatic group, and the heterocyclic group described for the monovalent organic group in the organic group described for the organic group represented by R¹¹ and R¹², in which the aliphatic group is preferred. The number of carbon atoms of the aliphatic group is preferably 1 or more, and the upper limit thereof is preferably 20 or less, more preferably 16 or less, further preferably 12 or less, and still further preferably 4 or less, and a methyl group is particularly preferred.

n₁₁ represents 0 or 1, and preferably represents 0 from the standpoint of reducing the oil absorption, easily providing the excellent coating suitability, and providing the excellent battery capabilities more efficiently.

As for the preferred combination of R¹¹, R¹², X₁₁, and nu in the general formula (1) in the case where X₁₁ represents a single bond, it is preferred that R¹¹ represents a single bond, R¹² represents an aliphatic group, and nu represents 0, in which the aliphatic group represented by R¹² is preferably an alkyl group, and the number of carbon atoms of the alkyl group is as described above.

Typical preferred examples of the compound (1) of this type include heptanal (represented by the general formula (1), in which R¹¹ and Xn represent single bonds, n₁₁ represents 0, and R¹² represents a hexyl group), hexanal (represented by the general formula (1), in which R¹¹ and Xn represent single bonds, nu represents 0, and R¹² represents a pentyl group), and undecanal (represented by the general formula (1), in which R¹¹ and X₁₁ represent single bonds, nu represents 0, and R¹² represents a decyl group). It is obvious that any of compounds that have the similar structure can also provide the similar effects.

As for the preferred combination of R¹¹, R¹², X₁₁, and nu in the general formula (1) in the case where X₁₁ represents an oxygen atom, it is preferred that R¹¹ represents an aliphatic group, R¹² represents an aromatic group, and n₁₁ represents 0, in which the aliphatic group represented by R¹¹ is preferably an alkyl group, and the number of carbon atoms of the alkyl group is as described above. The aromatic group represented by R¹² is preferably an aromatic group having a monocyclic aromatic compound as the basic structure, more preferably a group obtained by removing one hydrogen atom to form a bonding site from an aliphatic group (preferably an alkyl group), the aliphatic group (preferably an alkyl group) being bonded to an aromatic ring, in which a benzyl group, a phenylethyl group, and a phenylpropyl group are preferred, and a benzyl group is more preferred.

Typical preferred examples of the compound (1) of this type include benzyloxyacetaldehyde (represented by the general formula (1), in which X₁₁ represents an oxygen atom, R¹¹ represents a methylene group, nu represents 0, and R¹² represents a benzyl group). It is obvious that any of compounds that have the similar structure can also provide the similar effects.

As for the preferred combination of R¹¹, R¹², X₁₁, and nu in the general formula (1) in the case where X₁₁ represents a group represented by the general formula (1a), it is preferred that R¹¹ and R¹² represent aliphatic groups, and n₁₁ represents 0, and as for X₁₁, R^{11a} and R^{12a} in the general formula (1a) each preferably represent an aliphatic group.

The aliphatic group represented by R¹¹ is preferably an alkyl group, in which the number of carbon atoms thereof is preferably 1 or more, the upper limit thereof is preferably 20 or less, more preferably 16 or less, further preferably 12 or less, and still further preferably 4 or less, and a methyl group is particularly preferred. The aliphatic group represented by R¹² is preferably an alkyl group, more preferably an alkyl group having a branched chain, and the alkyl group having a branched chain is preferably a tertiary alkyl group (i.e., an alkyl group having a structure including three carbon atoms bonded to one carbon atom).

The number of carbon atoms of the aliphatic group represented by R¹² is preferably 3 or more, and more preferably 4 or more, and the upper limit thereof is preferably 20 or less, more preferably 16 or less, further preferably 12 or less, and still further preferably 6 or less. The aliphatic group represented by R^{11a} and R^{12a} in the general formula (1a) is preferably an alkyl group, in which the number of carbon atoms thereof is preferably 1 or more, the upper limit thereof is preferably 20 or less, more preferably 16 or less, further preferably 12 or less, and still further preferably 4 or less, and a methyl group is particularly preferred.

In the modified sulfide solid electrolyte of the present embodiment, the compound (1) may be used alone, or multiple kinds thereof may be used in combination.

### (Compound (2))

The compound (2) used in the modified sulfide solid electrolyte of the present embodiment is a compound having one or more acetyl group (CH₃C(═O)—). Preferred examples of the compound (2) include a compound represented by the following general formula (2), and thereby the oil absorption is reduced, the excellent coating suitability can be easily obtained, and the excellent battery capabilities can be obtained more efficiently.

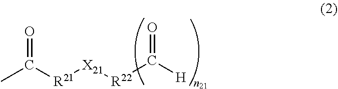

In the general formula (2), R²¹ and R²² each independently represent an organic group or a single bond, X₂₁ represents an oxygen atom, a sulfur atom, or a single bond, and n₂₁ represents 0 or 1.

The organic group represented by R²¹ and R²² is a divalent organic group, and examples thereof include a divalent aliphatic group, a divalent alicyclic group, a divalent aromatic group, and a divalent heterocyclic group in the organic groups described for the organic group represented by R¹¹ and R¹², in which a divalent aliphatic group is preferred. The divalent aliphatic group, the divalent alicyclic group, the divalent aromatic group, and the divalent heterocyclic group are the same as described for the organic groups described for R¹¹ and R 12.

As for the preferred combination of R²¹, R²², and X₂₁ in the general formula (2), it is preferred that any one of R²¹ and R²² represents an aliphatic group, the other one thereof represents a single bond, and X₂₁ represents a single bond, and the aliphatic group represented by any one of R²¹ and R²² is preferably an alkanediyl group.

The number of carbon atoms of the alkanediyl group is as described for the number of carbon atoms of the divalent aliphatic group represented by R¹¹ and R¹², i.e., is preferably 1 or more, and the upper limit thereof is preferably 12 or less, more preferably 8 or less, further preferably 4 or less, and still further preferably 3 or less.

X₂₁ represents an oxygen atom, a sulfur atom, or a single bond. X₂₁ preferably represents a single bond from the standpoint of reducing the oil absorption, easily providing the excellent coating suitability, and easily providing the excellent battery capabilities more efficiently.

n₂₁ represents 0 or 1. n₂₁ preferably represents 0 from the standpoint of reducing the oil absorption, easily providing the excellent coating suitability, and easily providing the excellent battery capabilities more efficiently.

Typical preferred examples of the compound (2) of this type include acetylacetone (represented by the general formula (2), in which R²¹ and X₂₁ represent single bonds, R²² represents a methylene group, and n₂₁ represents 1). Preferred examples of the compound (2) of this type also include benzyloxyacetone (represented by the general formula (2), in which X₂₁ represents an oxygen atom, R²¹ represents a methylene group, R²² represents a benzyl group, and n₂₁ represents 0). It is obvious that any of compounds that have the similar structure can also provide the similar effects.

In the modified sulfide solid electrolyte of the present embodiment, the compound (2) may be used alone, or multiple kinds thereof may be used in combination.

### (Compound (3))

The compound (3) used in the modified sulfide solid electrolyte of the present embodiment is a compound having two or more halogen-containing groups represented by —CH₂X (in which X represents a fluorine atom or a bromine atom) and an organic group. Preferred examples of the compound (3) include a compound represented by the following general formula (3), and thereby the oil absorption is reduced, the excellent coating suitability can be easily obtained, and the excellent battery capabilities can be obtained more efficiently.

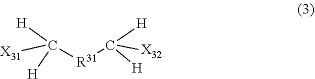

In the general formula (3), R³¹ represents an organic group or a single bond, and X₃₁ and X₃₂ each independently represent a fluorine atom or a bromine atom.

The organic group represented by R³¹ is a divalent organic group, and examples thereof include a divalent aliphatic group, a divalent alicyclic group, a divalent aromatic group, and a divalent heterocyclic group in the organic groups described for the organic group represented by R¹¹ and R¹², in which a divalent aliphatic group is preferred.

Examples of the divalent aliphatic group include a group obtained by removing one hydrogen atom to form a bonding site in the monovalent aliphatic group described above, i.e., an alkanediyl group, an alkenediyl group, and an alkynediyl group, as similar to the divalent aliphatic group represented by R¹¹ and R¹². An alkanediyl group and an alkenediyl group are preferred, and an alkanediyl group is more preferred, from the standpoint of reducing the oil absorption, easily providing the excellent coating suitability, and providing the excellent battery capabilities more efficiently.

The number of carbon atoms of the divalent aliphatic group is preferably 1 or more, and the upper limit thereof is preferably 20 or less, more preferably 16 or less, further preferably 12 or less, and still further preferably 10 or less.

The aliphatic group may be either linear or branched, and is preferably linear. The other matters therefor are the same as in the aliphatic group represented by R¹¹ and R¹².

A divalent alicyclic group, a divalent aromatic group, and a divalent heterocyclic group that are capable of becoming the organic group represented by R³¹ are the same as described for the alicyclic group, the aromatic group, and the heterocyclic group in the organic group represented by R¹¹ and R¹².

R³¹ may represent either the organic group above or a single bond, and preferably represents the organic group from the standpoint of reducing the oil absorption, easily providing the excellent coating suitability, and providing the excellent battery capabilities more efficiently.

X₃₁ and X₃₂ each independently represent a fluorine atom or a bromine atom, and X₃₁ and X₃₂ may be the same as or different from each other, and are preferably the same as each other from the standpoint of reducing the oil absorption, easily providing the excellent coating suitability, and providing the excellent battery capabilities more efficiently. Either a fluorine atom or a bromine atom may be used, and a bromine atom is preferred from the same standpoint.

Representative preferred examples of the compound (3) of this type include a dibromoalkane, such as 1,3-dibromopropane (represented by the general formula (3), in which R³¹ represents a methylene group, and X₃₁ and X₃₂ represent bromine atoms), 1,4-dibromobutane (represented by the general formula (3), in which R³¹ represents a methylene group, and X₃₁ and X₃₂ represent bromine atoms), 1,6-dibromohexane (represented by the general formula (3), in which R³¹ represents a 1,4-butanediyl group, and X₃₁ and X₃₂ represent bromine atoms), and 1,10-dibromodecane (represented by the general formula (3), in which R³¹ represents a 1,8-octanediyl group, and X₃₁ and X₃₂ represent bromine atoms). A dihalogenated alkyl group having one bromine atom as a halogen atom bonded to each of the end carbon atoms, such as the compounds above, is particularly preferred. It is obvious that any of compounds that have the similar structure can also provide the similar effects.

In the modified sulfide solid electrolyte of the present embodiment, the compound (3) may be used alone, or multiple kinds thereof may be used in combination.

### (Compound (4))

The compound (4) used in the modified sulfide solid electrolyte of the present embodiment is a thiol compound. Preferred examples of the compound (4) include a compound represented by the following general formula (4-1) and the following general formula (4-2), and thereby the oil absorption is reduced, the excellent coating suitability can be easily obtained, and the excellent battery capabilities can be obtained more efficiently.

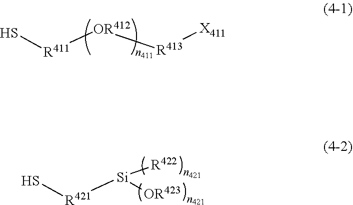

In the general formula (4-1), R⁴¹¹, R⁴¹², and R⁴¹³ each independently represent an organic group or a single bond, X₄₁₁ represents a hydrogen atom or a thiol group, and n₄₁₁ represents an integer of 0 to 3, provided that at least one of R⁴¹¹, R⁴¹², and R⁴¹³ represents an organic group.

In the general formula (4-2), R⁴²¹, R⁴²², and R⁴²³ each independently represent an organic group, and n₄₂₁ and n₄₂₂ each represent an integer of 0 to 3, in which n₄₂₁ and n₄₂₂ satisfy n₄₂₁+n₄₂₂=3.

The organic group represented by R⁴¹¹, R⁴¹², and R⁴¹³ is a divalent organic group, and examples thereof include a divalent aliphatic group, a divalent alicyclic group, a divalent aromatic group, and a divalent heterocyclic group in the organic groups described for the organic group represented by R¹¹ and R¹², in which a divalent aliphatic group is preferred.

The number of carbon atoms of the divalent aliphatic groups represented by R⁴¹¹ and R⁴¹³ is preferably 1 or more, and the upper limit thereof is preferably 24 or less, more preferably 20 or less, further preferably 16 or less, and still further preferably 12 or less, from the standpoint of reducing the oil absorption, easily providing the excellent coating suitability, and providing the excellent battery capabilities more efficiently.

The number of carbon atoms of the divalent aliphatic group represented by R⁴¹² is preferably 1 or more, and the upper limit thereof is preferably 8 or less, more preferably 6 or less, further preferably 4 or less, and still further preferably 2 or less, from the same standpoint. In the case where multiple groups represented by R⁴² exist (i.e., in the case where n₄₁₁ represents an integer of 2 or 3), the multiple groups represented by R⁴¹² may be the same as or different from each other, and are preferably the same as each other.

The aliphatic group may be either linear or branched, and is preferably linear. The other matters therefor are the same as in the aliphatic group represented by R¹¹ and R¹².

A divalent alicyclic group, a divalent aromatic group, and a divalent heterocyclic group that are capable of becoming the organic groups represented by R⁴¹¹, R⁴¹², and R⁴¹³ are the same as described for the alicyclic group, the aromatic group, and the heterocyclic group in the organic group represented by R¹¹ and R¹².

R⁴¹¹, R⁴¹², and R⁴¹³ may represent a single bond as described above, and it is preferred that at least one thereof represents the organic group above from the standpoint of reducing the oil absorption, easily providing the excellent coating suitability, and providing the excellent battery capabilities more efficiently.

X₄₁₁ represents either a hydrogen atom or a thiol group, and preferably represents a hydrogen atom from the standpoint of reducing the oil absorption, easily providing the excellent coating suitability, and providing the excellent battery capabilities more efficiently. In other words, the compound (4) may be either a monothiol compound having one thiol group or a dithiol compound having two thiol groups, and is preferably a monothiol compound.

n₄₁₁ represents an integer of 0 to 3, preferably represents 0 or 1, and more preferably 0, from the same standpoint.

The organic group represented by R⁴²¹ is a divalent organic group, and examples thereof include a divalent aliphatic group, a divalent alicyclic group, a divalent aromatic group, and a divalent heterocyclic group in the organic groups described for the organic group represented by R¹¹ and R¹², in which a divalent aliphatic group or a divalent aromatic group are preferred, and a divalent aromatic group is preferred. The divalent aliphatic group, the divalent alicyclic group, the divalent aromatic group, and the divalent heterocyclic group are the same as described for the organic groups represented by R¹¹ and R¹².

The number of carbon atoms of the divalent aliphatic group represented by R⁴²¹ is preferably 1 or more, and more preferably 2 or more, and the upper limit thereof is preferably 12 or less, more preferably 8 or less, and further preferably 4 or less, from the standpoint of reducing the oil absorption, easily providing the excellent coating suitability, and providing the excellent battery capabilities more efficiently.

In the general formula (4-2), R⁴²² and R⁴²³ each represent a monovalent organic group, and examples thereof include a monovalent aliphatic group, a monovalent alicyclic group, a monovalent aromatic group, and a monovalent heterocyclic group in the organic groups described for the organic group represented by R¹¹ and R¹², in which a monovalent aliphatic group is preferred. The monovalent aliphatic group, the monovalent alicyclic group, the monovalent aromatic group, and the monovalent heterocyclic group are the same as described for the organic groups represented by R¹¹ and R¹².

The number of carbon atoms of the monovalent aliphatic groups represented by R⁴²² and R⁴²³ is preferably 1 or more, and the upper limit thereof is preferably 12 or less, more preferably 8 or less, further preferably 4 or less, and still further preferably 2 or less, from the standpoint of reducing the oil absorption, easily providing the excellent coating suitability, and providing the excellent battery capabilities more efficiently.

In the case where multiple groups represented by R⁴²² or R⁴²³ exist (i.e., in the case where n₄₂₁ represents an integer of 1 or 2), the multiple groups represented by R⁴²² or R⁴²³ may be the same as or different from each other, and are preferably the same as each other.

The aliphatic groups represented by R⁴²¹, R⁴²², and R⁴²³ each may be either linear or branched, and is preferably linear. The other matters therefor are the same as in the aliphatic group represented by R¹¹ and R¹².

A monovalent or divalent alicyclic group, a monovalent or divalent aromatic group, and a monovalent or divalent heterocyclic group that are capable of becoming the organic groups represented by R⁴²¹, R⁴²², and R⁴²³ are the same as described for the alicyclic group, the aromatic group, and the heterocyclic group in the organic group represented by R¹¹ and R¹².

As for the compound (4) of this type, representative preferred examples of the compound represented by the general formula (4-1) include 1-dodecanethiol (represented by the general formula (4-1), in which R⁴¹¹ represents a single bond, nan represents 0, R⁴¹³ represents 1,12-dodecanediyl group, and X₄₁₁ represents a hydrogen atom) and 1,10-decanedithiol (represented by the general formula (4-1), in which R⁴¹¹ represents a single bond, n₄₁₁ represents 0, R⁴¹³ represents 1,10-decanediyl group, and X₄₁₁ represents a thiol group). Representative preferred examples of the compound represented by the general formula (4-2) include 3-mercaptopropyltrimethoxysilane (represented by the general formula (4-2), in which R⁴²¹ represents a 1,3-propanediyl group, R⁴²³ represents a methyl group, n₄₂₁ represents 0, and n₄₂₂ represents 3). It is obvious that any of compounds that have the similar structure can also provide the similar effects.

In the modified sulfide solid electrolyte of the present embodiment, the compound (4) may be used alone, or multiple kinds thereof may be used in combination, and at least one kind of a compound selected from the compound represented by the general formula (4-1) and the compound represented by general formula (4-2) may be used. For example, the compound represented by general formula (4-1) may be used alone, or two kinds of the compounds represented by the general formula (4-1) may be used in combination, and the compound represented by general formula (4-2) is also the same. For example, furthermore, one kind or multiple kinds of the compound represented by general formula (4-1) and one kind or multiple kinds of the compound represented by general formula (4-2) may be used in combination.

### (Compound (5))

The compound (5) used in the modified sulfide solid electrolyte of the present embodiment is a metal-free phosphorus compound (provided that the compound does not contain an oxygen atom that is bonded to a phosphorus atom via a single bond). It suffices that the compound (5) is a phosphorus compound that does not contain a metal atom, provided that the compound does not contain an oxygen atom that is bonded to a phosphorus atom via a single bond. Accordingly, the compound (5) does not encompass a compound having a phosphorus atom bonded to a hydrocarbon group via oxygen, for example a compound having various organic groups bonded to a phosphorus atom via an alkoxy group or an ether bond.

Preferred examples of the compound (5) include a compound represented by the following general formula (5-1), and thereby the oil absorption is reduced, the excellent coating suitability can be easily obtained, and the excellent battery capabilities can be obtained more efficiently.

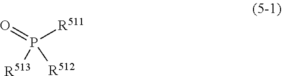

In the general formula (5-1), R⁵¹¹, R⁵¹², and R⁵¹³ each independently represent an organic group.

The organic group represented by R⁵¹¹, R³¹², and R⁵¹³ is a monovalent organic group, and examples thereof include a monovalent aliphatic group, a monovalent alicyclic group, a monovalent aromatic group, and a monovalent heterocyclic group in the organic groups described for the organic group represented by R¹¹ and R¹², in which a monovalent aliphatic group is preferred. The monovalent aliphatic group, the monovalent alicyclic group, the monovalent aromatic group, and the monovalent heterocyclic group are the same as described for the organic groups represented by R¹¹ and R¹².

The number of carbon atoms of the monovalent aliphatic group represented by R⁵¹¹, R⁵¹², and R⁵¹³ is preferably 1 or more, more preferably 2 or more, and further preferably 3 or more, and the upper limit thereof is preferably 20 or less, more preferably 16 or less, further preferably 12 or less, and still further preferably 10 or less, from the standpoint of reducing the oil absorption, easily providing the excellent coating suitability, and providing the excellent battery capabilities more efficiently.

The aliphatic groups each may be either linear or branched, and is preferably linear. The other matters therefor are the same as in the aliphatic group represented by R¹¹ and R¹².

A monovalent alicyclic group, a monovalent aromatic group, and a monovalent heterocyclic group that are capable of becoming the organic groups represented by R⁵¹¹, R⁵¹² and R⁵¹³ are the same as described for the alicyclic group, the aromatic group, and the heterocyclic group in the organic group represented by R¹¹ and R¹².

R⁵¹¹, R⁵¹², and R⁵¹³ each may represent an organic group having an oxygen atom, and for example, may represent a group having a group selected from the monovalent alicyclic group, the monovalent alicyclic group, the monovalent aromatic group, and the monovalent heterocyclic group, bonded via an oxygen atom. In this case, the monovalent organic group bonded via an oxygen atom is preferably a group having an oxygen atom and an aliphatic group.

Representative preferred examples of the compound (5) represented by the general formula (5-1) include tri-n-octylphosphine oxide (represented by the general formula (5-1), in which R⁵¹¹, R⁵¹², and R⁵¹³ represent 1-octyl groups). It is obvious that any of compounds that have the similar structure can also provide the similar effects.

Preferred examples of the compound (5) include a compound represented by the following general formula (5-2).

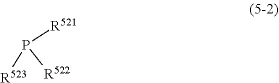

In the general formula (5-2), R⁵²¹, R⁵²², and R⁵²³ each independently represent an organic group.

The organic group represented by R⁵¹¹, R⁵¹², and R⁵¹³ is a monovalent organic group, and examples thereof include a monovalent aliphatic group, a monovalent alicyclic group, a monovalent aromatic group, and a monovalent heterocyclic group in the organic groups described for the organic group represented by R¹¹ and R¹², in which a monovalent aliphatic group and a monovalent aromatic group are preferred. The monovalent aliphatic group, the monovalent alicyclic group, the monovalent aromatic group, and the monovalent heterocyclic group are the same as described for the organic groups represented by R¹¹ and R¹².

The number of carbon atoms of the monovalent aliphatic group represented by R⁵²¹, R⁵²², and R⁵²³ is preferably 1 or more, more preferably 2 or more, and further preferably 3 or more, and the upper limit thereof is preferably 20 or less, more preferably 16 or less, further preferably 12 or less, and still further preferably 10 or less, from the standpoint of reducing the oil absorption, easily providing the excellent coating suitability, and providing the excellent battery capabilities more efficiently.

The aliphatic group may be either linear or branched, and is preferably linear. The other matters therefor are the same as in the aliphatic group represented by R¹¹ and R¹².

The monovalent aromatic group represented by R⁵²¹, R⁵²², and R⁵²³ is preferably an aromatic group having a monocyclic aromatic compound as the basic structure in the aromatic group described for the aromatic group represented by R¹¹ and R¹², in which a phenyl group is more preferred.

R⁵²¹, R⁵²², and R⁵²³ each may represent an organic group having an oxygen atom, and for example, may represent a group having a group selected from the monovalent alicyclic group, the monovalent alicyclic group, the monovalent aromatic group, and the monovalent heterocyclic group, bonded via an oxygen atom. In this case, the monovalent organic group bonded via an oxygen atom is preferably a group having an oxygen atom and an aliphatic group.

Representative preferred examples of the compound (5) represented by the general formula (5-2) include tri-n-octylphosphine (represented by the general formula (5-2), in which R⁵²¹, R⁵²², and R⁵²³ represent 1-octyl groups) and triphenylphosphine (represented by the general formula (5-2), in which R⁵²¹, R⁵²², and R⁵²³ represent phenyl groups). It is obvious that any of compounds that have the similar structure can also provide the similar effects.

Preferred examples of the compound (5) include a compound represented by the following general formula (5-3).

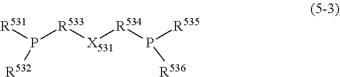

In the general formula (5-3), R⁵³¹, R⁵³², R⁵³⁵, and R⁵³⁶ each independently represent an organic group. R⁵³³ and R⁵³⁴ each independently represent a single bond or an organic group, and X₅₃₁ represents a single bond or an oxygen atom. At least one of R⁵³³ and R⁵³⁴ represents an organic group, and R⁵³³ and R⁵³⁴ may be bonded to each other to form a condensed ring.

The organic group represented by R⁵³¹, R⁵³², R⁵³⁵, and R⁵³⁶ is a monovalent organic group, and examples thereof include a monovalent aliphatic group, a monovalent alicyclic group, a monovalent aromatic group, and a monovalent heterocyclic group in the organic groups described for the organic group represented by R¹¹ and R¹², in which a monovalent aliphatic group and a monovalent aromatic group are preferred, and a monovalent aromatic group is more preferred. The monovalent aliphatic group, the monovalent alicyclic group, the monovalent aromatic group, and the monovalent heterocyclic group are the same as described for the organic groups represented by R¹¹ and R¹².

The monovalent aromatic group represented by R⁵³¹, R⁵³², R⁵³⁵, and R⁵³⁶ is preferably an aromatic group having a monocyclic aromatic compound as the basic structure in the aromatic group described for the aromatic group represented by R¹¹ and R¹², and more preferably a phenyl group.

R⁵³¹, R⁵³², R⁵³⁵, and R⁵³⁶ each may represent an organic group having an oxygen atom, and for example, may represent a group having a group selected from the monovalent alicyclic group, the monovalent alicyclic group, the monovalent aromatic group, and the monovalent heterocyclic group, bonded via an oxygen atom. In this case, the monovalent organic group bonded via an oxygen atom is preferably a group having an oxygen atom and an aliphatic group, and a group having an oxygen atom and an aromatic group.

The organic group represented by R⁵³³ and R⁵³⁴ is a divalent organic group, and examples thereof include a divalent aliphatic group, a divalent alicyclic group, a divalent aromatic group, and a divalent heterocyclic group in the organic groups described for the organic group represented by R¹¹ and R¹², in which a divalent aliphatic group or a divalent aromatic group are preferred, and a divalent aromatic group is preferred. The divalent aliphatic group, the divalent alicyclic group, the divalent aromatic group, and the divalent heterocyclic group are the same as described for the organic groups represented by R¹¹ and R 12.

The number of carbon atoms of the divalent aliphatic group represented by R⁵³³ and R⁵³⁴ is preferably 1 or more, more preferably 2 or more, and further preferably 3 or more, and the upper limit thereof is preferably 16 or less, more preferably 12 or less, further preferably 8 or less, and still further preferably 6 or less, from the standpoint of reducing the oil absorption, easily providing the excellent coating suitability, and providing the excellent battery capabilities more efficiently.

The aliphatic group may be either linear or branched, and is preferably linear. The other matters therefor are the same as in the aliphatic group represented by R¹¹ and R¹².

The divalent aromatic group represented by R⁵³³ and R⁵³⁴ may be a divalent aromatic group in the aromatic group described for the aromatic group represented by R¹¹ and R¹², and may be a group obtained by removing two hydrogen atoms to form bonding sites from the basic structure of the monocyclic aromatic compound, the bonded polycyclic aromatic compound, and the condensed polycyclic aromatic compound described above, and preferably a group obtained by removing two hydrogen atoms to form bonding sites from the basic structure of the monocyclic aromatic compound and the condensed polycyclic aromatic compound described above.

At least one of R⁵³³ and R⁵³⁴ represents an organic group.

R⁵³³ and R⁵³⁴ may be bonded to each other to form a condensed ring. In this case, X₅₃₁ represents a single bond. Examples of the condensed ring in this case include the condensed ring described for the alicyclic group, the aromatic group, and the heterocyclic group represented by R¹¹ and R¹².

In the case where X₅₃₁ represents an oxygen atom, R⁵³³, X₅₃₁, and R⁵³⁴ may be bonded to each other to form a condensed ring. Examples of the condensed ring in this case include the condensed polycyclic heterocyclic compound containing oxygen described for the heterocyclic group represented by R¹¹ and R 12.

Representative preferred examples of the compound (5) represented by the general formula (5-3) include 1,4-bis(diphenylphosphino) butane (represented by the general formula (5-3), in which R⁵³¹, R⁵³², R⁵³⁵, and R⁵³⁶ represent phenyl groups, R⁵³³ represents a 1,4-butanediyl group, and R⁵³⁴ and X₅₃₁ represent single bonds), bis((2-diphenylphosphino)phenyl) ether (represented by the general formula (5-3), in which R⁵³¹, R⁵³², R⁵³⁵, and R⁵³⁶ represent phenyl groups, R⁵³³ and R⁵³⁴ represent benzenediyl groups, and X₅₃₁ represents an oxygen atom), and 4,5-bis(diphenylphosphino)-9,9-dimethylxanthene (represented by the general formula (5-3), in which R⁵³¹, R⁵³², R⁵³⁵, and R⁵³⁶ represent phenyl groups, R⁵³³ represents a xanthen-4,5-diyl group, and R⁵³⁴ and X₅₃₁ represent single bonds, which may also be considered that R⁵³³ represents a dihydrobenzopyranyl group, R⁵³⁴ represents a phenyl group, R⁵³³ and R 534 are condensed to each other to form a xanthen-4,5-diyl group). It is obvious that any of compounds that have the similar structure can also provide the similar effects.

In the modified sulfide solid electrolyte of the present embodiment, the compound (5) may be used alone, or multiple kinds thereof may be used in combination, and at least one kind of a compound selected from the compound represented by the general formula (5-1), the compound represented by the general formula (5-2), and the compound represented by the general formula (5-3) may be used. For example, the compound represented by general formula (5-1) may be used alone, or two kinds of the compounds represented by the general formula (5-1) may be used in combination, and the compounds represented by the general formulae (5-2) and (5-3) are also the same. For example, furthermore, one kind or multiple kinds of the compound represented by general formula (5-1) and one kind or multiple kinds of the compound represented by general formula (5-2) may be used in combination, and the combination of the compound represented by the general formula (5-2) and the compound represented by the general formula (5-3), and the combination of the compound represented by the general formula (5-1) and the compound represented by the general formula (5-3) are also the same.

The molecular weight of the compound (5) is preferably 3,000 or less, more preferably 2,000 or less, further preferably 1,500 or less, and still further preferably 1,000 or less, from the standpoint of reducing the oil absorption, easily providing the excellent coating suitability, and providing the excellent battery capabilities more efficiently.

### (Compound (6))

The compound (6) used in the modified sulfide solid electrolyte of the present embodiment is a metal-free boron compound. It suffices that the compound (6) is a boron compound that does not contain a metal. Preferred examples of the compound (6) include a compound represented by the following general formula (6), and thereby the oil absorption is reduced, the excellent coating suitability can be easily obtained, and the excellent battery capabilities can be obtained more efficiently.

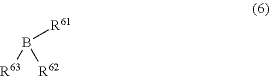

In the general formula (6), R⁶¹, R⁶², and R⁶³ each independently represent an organic group.

The organic group represented by R⁶¹, R⁶², and R⁶³ is a monovalent organic group, and examples thereof include a monovalent aliphatic group, a monovalent alicyclic group, a monovalent aromatic group, and a monovalent heterocyclic group in the organic groups described for the organic group represented by R¹¹ and R¹², in which a monovalent aliphatic group is preferred. The monovalent aliphatic group, the monovalent alicyclic group, the monovalent aromatic group, and the monovalent heterocyclic group are the same as described for the organic groups represented by R¹¹ and R¹².

The number of carbon atoms of the monovalent aliphatic group represented by R⁶¹, R⁶², and R⁶³ is preferably 1 or more, more preferably 2 or more, further preferably 4 or more, and still further preferably 6 or more, and the upper limit thereof is preferably 28 or less, more preferably 24 or less, further preferably 20 or less, and still further preferably 18 or less, from the standpoint of reducing the oil absorption, easily providing the excellent coating suitability, and providing the excellent battery capabilities more efficiently.

The aliphatic group may be either linear or branched, and is preferably linear. The other matters therefor are the same as in the aliphatic group represented by R¹¹ and R¹².

R⁶¹, R⁶², and R⁶³ each also preferably represent an organic group having an oxygen atom. Examples of the organic group having an oxygen atom include a group having a group selected from the monovalent alicyclic group, the monovalent alicyclic group, the monovalent aromatic group, and the monovalent heterocyclic group, bonded via an oxygen atom. In this case, the monovalent organic group bonded via an oxygen atom is preferably a group having an oxygen atom and an aliphatic group, and particularly preferably a group having an oxygen atom and an alkyl group, i.e., an alkoxy group. The number of carbon atoms of the aliphatic group may be the same as the preferred number of carbon atoms of the monovalent aliphatic group represented by R⁶¹, R⁶², and R⁶³ described above.

Representative preferred examples of the compound (6) represented by the general formula (6) include tri-n-octyl borate (represented by the general formula (6), in which R⁶¹, R⁶², and R⁶³ represent octyloxy groups) and tri-n-octadecyl borate (represented by the general formula (6), in which R⁶¹, R⁶², and R⁶³ represent octadecyloxy groups). It is obvious that any of compounds that have the similar structure can also provide the similar effects.

In the modified sulfide solid electrolyte of the present embodiment, the compound (6) may be used alone, or multiple kinds thereof may be used in combination.

The compounds (1) to (4) and (6) each are preferably a compound that has a prescribed molecular weight from the standpoint of easily providing the excellent coating suitability, and providing the excellent battery capabilities more efficiently, as similar to the compound (5). Specifically, the molecular weight of the compounds (1) to (4) and (6) is preferably 3,000 or less, more preferably 2,000 or less, further preferably 1,500 or less, and still further preferably 1,000 or less, from the standpoint of easily providing the excellent coating suitability, and providing the excellent battery capabilities more efficiently.

The content of the at least one compound selected from the compounds (1) to (6) that has a molecular weight of 3,000 or less with respect to the total content of the at least one compound selected from the compounds (1) to (6) in the modified sulfide solid electrolyte is preferably 90% by mass or more, more preferably 95% by mass or more, further preferably 99% by mass or more, and still further preferably 100% by mass, i.e., it is still further preferred that the total amount thereof is occupied by the compounds having a number average molecular weight of 3,000 or more.

Conversely, the content of the at least one compound selected from the compounds (1) to (6) that has a molecular weight exceeding 3,000 with respect to the total content of the at least one compound selected from the compounds (1) to (6) in the modified sulfide solid electrolyte is preferably 10% by mass or less, more preferably 5% by mass or less, further preferably 1% by mass or less, and still further preferably 0% by mass, i.e., it is still further preferred that the compound having a molecular weight exceeding 3,000 is not contained.

The content of the compounds (1) to (6) contained in the modified sulfide solid electrolyte may vary depending on the kinds of the compounds used, and therefore cannot be determined unconditionally, and the content thereof is preferably 0.03 part by mass or more, more preferably 0.05 part by mass or more, further preferably 0.1 part by mass or more, and still further preferably 0.5 part by mass or more, and the upper limit thereof is preferably 25 parts by mass or less, and more preferably 20 parts by mass or less, per 100 parts by mass of the sulfide solid electrolyte. In the case where the content thereof is in the range, the coating suitability in coating as a paste can be efficiently enhanced, and the excellent battery capabilities can be obtained more efficiently.

In the modified sulfide solid electrolyte of the present embodiment, at least one compound selected from the compounds (1) to (6) is used. Specifically, the compounds (1) to (6) each may be used alone, multiple kinds of each of the compounds (1) to (6), for example, multiple kinds of the compound (1), may be used in combination, or two or more kinds of compounds selected from the compounds (1) to (6) may be used in combination.

### (Production of Sulfide Solid Electrolyte)

The sulfide solid electrolyte for forming the modified sulfide solid electrolyte of the present embodiment is then described. The sulfide solid electrolyte used in the present embodiment is not particularly limited, as long as containing a lithium atom, a sulfur atom, a phosphorus atom, and a halogen atom, and having a BET specific surface area of 10 m²/g or more, and a commercially available product or a produced product may be used.

As for the case where the sulfide solid electrolyte used in the present embodiment is produced, the method of producing the same is described. The sulfide solid electrolyte used in the present embodiment can be produced, for example, by a production method including mixing two or more kinds of raw materials selected from compounds containing at least one atom of a lithium atom, a sulfur atom, a phosphorus atom, and a halogen atom.

### (Raw Materials)

Two or more kinds of compounds selected from compounds containing at least one atom of a lithium atom, a sulfur atom, a phosphorus atom, and a halogen atom can be used as the raw materials.

The compound used as the raw material contains at least one atom of a lithium atom, a sulfur atom, a phosphorus atom, and a halogen atom, and more specifically, representative examples thereof include a raw material containing at least two kinds of atoms selected from the four kinds of atoms above, for example, lithium sulfide; a lithium halide, such as lithium fluoride, lithium chloride, lithium bromide, and lithium iodide; an alkali metal halide, such as a sodium halide, e.g., sodium iodide, sodium fluoride, sodium chloride, and sodium bromide; a phosphorus sulfide, such as diphosphorus trisulfide (P₂S₃) and diphosphorus pentasulfide (P₂S₅); a phosphorus halide, such as various phosphorus fluoride (e.g., PF₃ and PF₅), various phosphorus chloride (e.g., PCl₃, PCl₅, and P₂Cl₄), various phosphorus bromide (e.g., PBr₃ and PBr₅), and various phosphorus iodide (e.g., PI₃ and P₂I₄); a thiophosphoryl halide, such as thiophosphoryl fluoride (PSF₃), thiophosphoryl chloride (PSCl₃), thiophosphoryl bromide (PSBr₃), thiophosphoryl iodide (PSI₃), thiophosphoryl dichloride fluoride (PSCl₂F), and thiophosphoryl dibromide fluoride (PSBr₂F); and an elemental halogen, such as fluorine (F₂), chlorine (Cl₂), bromine (Br₂), and iodine (I₂), preferably bromine (Br₂) and iodine (I₂).

Examples of the compound that can be used in addition to the raw materials described above include a compound containing at least one kind of an atom selected from the four kinds of atoms above and containing an atom other than the four kinds of atoms, and more specifically, examples thereof include a lithium compound, such as lithium oxide, lithium hydroxide, and lithium carbonate; an alkali metal sulfide, such as sodium sulfide, potassium sulfide, rubidium sulfide, and cesium sulfide; a metal sulfide, such as silicon sulfide, germanium sulfide, boron sulfide, gallium sulfide, tin sulfide (such as SnS and SnS₂), aluminum sulfide, and zinc sulfide; a phosphoric acid compound, such as sodium phosphate and lithium phosphate; a metal halide, such as an aluminum halide, a silicon halide, a germanium halide, an arsenic halide, a selenium halide, a tin halide, an antimony halide, a tellurium halide, and a bismuth halide; and a phosphorus oxyhalide, such as phosphorus oxychloride (POCl₃) and phosphorus oxybromide (POBr₃).

In the present embodiment, the halogen atom is preferably a chlorine atom, a bromine atom, or an iodine atom, and more preferably a bromine atom or an iodine atom, from the standpoint of providing a sulfide solid electrolyte having a high ionic conductivity more easily. These atoms may be used alone, or multiple kinds thereof may be used in combination. Specifically, taking a lithium halide as an example, lithium bromide may be used alone, lithium iodide may be used alone, or lithium bromide and lithium iodide may be used in combination.

From the same standpoint, the compound that can be used as the raw material is preferably a lithium sulfide; a phosphorus sulfide, such as diphosphorus trisulfide (P₂S₃) and diphosphorus pentasulfide (P₂S₅); an elemental halogen, such as fluorine (F₂), chlorine (Cl₂), bromine (Br₂), and iodine (I₂); or a lithium halide, such as lithium fluoride, lithium chloride, lithium bromide, and lithium iodide, among the above, in which diphosphorus pentasulfide is preferred as a phosphorus halide, chlorine (Cl₂), bromine (Br₂), and iodine (I₂) are preferred as an elemental halogen, and lithium chloride, lithium bromide, and lithium iodide are preferred as a lithium halide.

Preferred examples of the combination of the compounds that can be used as the raw material include a combination of lithium sulfide, diphosphorus pentasulfide, and a lithium halide, and a combination of lithium sulfide, diphosphorus pentasulfide, and an elemental halide, in which lithium bromide, lithium iodide, and lithium chloride are preferred as a lithium halide, and chlorine, bromine, and iodine are preferred as an elemental halide.

In the case where lithium sulfide is used as the compound containing a lithium atom in the present embodiment, the lithium sulfide is preferably in the form of particles.

The average particle diameter (D₅₀) of the lithium sulfide particles is preferably 10 μm or more and 2,000 μm or less, more preferably 30 μm or more and 1,500 μm or less, and further preferably 50 μm or more and 1,000 μm or less. In the description herein, the average particle diameter (D₅₀) means the diameter of the particles on the cumulative particle diameter distribution curve thereof, at which the cumulative value reaches 50% of the total from the smallest particle diameter side, and the volume distribution means an average particle diameter that can be measured, for example, with a laser diffraction-scattering particle diameter distribution analyzer. A solid raw material in the raw materials described above preferably has an average particle diameter that is equivalent to the lithium sulfide particles, i.e., preferably has an average particle diameter within the average particle diameter of the lithium sulfide particles described above.

In the case where lithium sulfide, diphosphorus pentasulfide, and a lithium halide are used as the raw material, the ratio of lithium sulfide with respect to the total of lithium sulfide and diphosphorus pentasulfide is preferably 60% by mol or more, more preferably 65% by mol or more, and further preferably 68% by mol or more, and the upper limit thereof is preferably 80% by mol or less, more preferably 78% by mol or less, and further preferably 76% by mol or less, from the standpoint of providing higher chemical stability, and the standpoint of enhancing the PS₄ fraction and providing a high ionic conductivity.

In the case where lithium sulfide, diphosphorus pentasulfide, a lithium halide, and other raw materials used depending on necessity are used, the content of lithium sulfide and diphosphorus pentasulfide based on the total thereof is preferably 60% by mol or more, more preferably 65% by mol or more, and further preferably 70% by mol or more, and the upper limit thereof is preferably 100% by mol or less, more preferably 90% by mol or less, and further preferably 80% by mol or less.

In the case where lithium bromide and lithium iodide are used as a lithium halide, the ratio of lithium bromide with respect to the total of lithium bromide and lithium iodide is preferably 1% by mol or more, more preferably 20% by mol or more, further preferably 40% by mol or more, and still further preferably 50% by mol or more, and the upper limit thereof is preferably 99% by mol or less, more preferably 90% by mol or less, further preferably 80% by mol or less, and still further preferably 70% by mol or less, from the standpoint of enhancing the PS₄ fraction and providing a high ionic conductivity.

In the case where an elemental halogen is used as the raw material, and in the case where lithium sulfide and diphosphorus pentasulfide are used, the ratio of the molar number of an elemental halogen and the molar number of lithium sulfide excluding the same molar number of lithium sulfide as the elemental halogen with respect to the molar number of an elemental halogen and the total molar number of lithium sulfide excluding the same molar number of lithium sulfide as the elemental halogen, and diphosphorus pentasulfide is preferably in a range of 60 to 90%, more preferably in a range of 65 to 85%, further preferably in a range of 68 to 82%, still further preferably in a range of 72 to 78%, and particularly preferably in a range of 73 to 77%, since the high ionic conductivity can be obtained with the ratio within the range. From the same standpoint, in the case where lithium sulfide, diphosphorus pentasulfide, and an elemental halogen are used, the content of an elemental halogen based on the total amount of lithium sulfide, diphosphorus pentasulfide, and an elemental halogen is preferably 1 to 50% by mol, more preferably 2 to 40% by mol, further preferably 3 to 25% by mol, and still further preferably 3 to 15% by mol.

In the case where lithium sulfide, diphosphorus pentasulfide, an elemental halogen, and a lithium halide are used, the content of an elemental halogen (a % by mol) and the content of a lithium halide (B % by mol) based on the total amount thereof preferably satisfy the following expression (1), more preferably satisfy the following expression (2), further preferably satisfy the following expression (3), and still further preferably satisfy the following expression (4).

$$2 \leq 2 α + β \leq 100 \qquad ( 1 )$$

$$4 \leq 2 α + β \leq 80 \qquad ( 2 )$$

$$6 \leq 2 α + β \leq 50 \qquad ( 3 )$$

$$6 \leq 2 α + β \leq 30 \qquad ( 4 )$$

### (Mixing)

Two or more kinds of the raw materials selected from compounds containing at least one atom of a lithium atom, a sulfur atom, a phosphorus atom, and a halogen atom may be mixed by using a mixer, or by using an agitator, a pulverizer, or the like.

The use of an agitator may cause mixing of the raw materials, and the use of a pulverizer causes pulverization of the raw materials, and simultaneously may cause mixing thereof. In other words, it can be understood that the sulfide solid electrolyte used in the present embodiment can be obtained by subjecting two or more kinds of the raw materials selected from compounds containing at least one atom of a lithium atom, a sulfur atom, a phosphorus atom, and a halogen atom to agitation, mixing, pulverization, or a treatment including any thereof in combination.

Examples of the agitator and the mixer include a mechanical agitation mixer capable of agitating with an agitation impeller provided inside a reaction tank (which can also be referred to as agitation mixing through agitation). Examples of the mechanical agitation mixer include a high-speed agitation mixer and a double arm mixer. Examples of the high-speed agitation mixer include a vertical shaft mixer and a horizontal shaft mixer, and any of the mixers can be used.

Examples of the shape of the agitation impeller used in the mechanical agitation mixer include a blade type, an arm type, an anchor type, a paddle type, a full zone type, a ribbon type, a multistage blade type, a twin arm type, a shovel type, a biaxial blade type, a flat blade type, and a C-type blade type, in which a shovel type, a flat blade type, and a C-type blade type, an anchor type, a paddle type, a full zone type, and the like are preferred, and an anchor type, a paddle type, and a full zone type are more preferred, from the standpoint of promoting the reaction of the raw materials more efficiently.

In the case where the mechanical agitation mixer is used, the rotation number of the agitation impeller is not particularly limited, but may be appropriately regulated corresponding to the volume and the temperature of the fluid in the reaction tank, the shape of the impeller, and the like, and is generally approximately 5 rpm or more and 400 rpm or less, preferably 10 rpm or more and 300 rpm or less, more preferably 15 rpm or more and 250 rpm or less, and further preferably 20 rpm or less and 200 rpm or less, from the standpoint of promoting the reaction of the raw materials more efficiently.

The temperature condition in mixing with the mixer is not particularly limited, and is, for example, generally-30 to 120° C., preferably-10 to 100° C., more preferably 0 to 80° C., and further preferably 10 to 60° C. The mixing time is generally 0.1 to 500 hours, and from the standpoint of making the dispersion state of the raw materials more uniform for promoting the reaction, preferably 1 to 450 hours, more preferably 10 to 425 hours, further preferably 20 to 400 hours, and still further preferably 40 to 375 hours.

The method of mixing associated with pulverization by using a pulverizer has been used as the solid phase method (mechanical milling method). Examples of the pulverizer used include a medium pulverizer using a pulverization medium.

The medium pulverizer is roughly classified into a vessel driven pulverizer and a medium agitation pulverizer. Examples of the vessel driven pulverizer include a ball mill and a bead mill including an agitation tank, a pulverization tank, or a combination thereof. Examples of the medium agitation pulverizer an impact pulverizer, such as a cutter mill, a hammer mill, and a pin mill; a tower pulverizer, such as a tower mill; an agitation tank type pulverizer, such as Attritor, AquaMizer, and a sand grinder; a flow tank type pulverizer, such as Viscomill and a pearl mill; a flow pipe type pulverizer; an annular pulverizer, such as a co-ball mill; a continuous dynamic pulverizer; and various pulverizer, such as a single screw or multiple screw kneader. Among these, a ball mill and a bead mill described for the vessel driven pulverizer are preferred, in which a planetary type thereof is more preferably, in consideration of ease of regulation of the particle diameter of the resulting sulfide and the like.

The pulverizer may be appropriately selected depending on the desired scale and the like, in which a vessel driven pulverizer, such as a ball mill and a bead mill, may be used for a relatively small scale, and another pulverizer may be used for a large scale or mass production.

In the case where the material to be mixed in a liquid state or a slurry state with a liquid, such as a solvent, in mixing as described later, a wet pulverizer capable of performing wet pulverization is preferred.

Representative examples of the wet pulverizer include a wet bead mill, a wet ball mill, and a wet vibration mill, in which a wet bead mill using beads as a pulverization medium is preferred since the condition of the pulverization operation can be freely adjusted to handle a material having a smaller particle diameter. A dry pulverizer, for example, a dry medium pulverizer, such as a dry bead mill, a dry ball mill, and a dry vibration mill, and a dry non-medium pulverizer, such as a jet pulverizer, may also be used.

In the case where the material to be mixed in a liquid state or a slurry state, a flow type pulverizer in which a circulation operation circulating the material is possible, may be used depending on necessity. Specific examples thereof include a pulverizer including a pulverizer (pulverizing mixer) and a thermal tank (reaction vessel), between which the slurry is circulated.

The size of the beads and the balls used in the ball mill and the bead mill may be appropriately selected depending on the desired particle diameter, the processing amount, and the like. For example, the diameter of the beads is generally 0.05 mm or more, preferably 0.1 mm or more, and more preferably 0.3 mm or more, and the upper limit thereof is generally 5.0 mm or less, preferably 3.0 mm or less, and more preferably 2.0 mm or less. The diameter of the balls is generally 2.0 mm or more, preferably 2.5 mm or more, and more preferably 3.0 mm or more, and the upper limit thereof is generally 20.0 mm or less, preferably 15.0 mm or less, and more preferably 10.0 mm or less.

Examples of the material thereof include a metal, such as a stainless steel, a chrome steel, and tungsten carbide; ceramics, such as zirconia and silicon nitride; and a mineral, such as agate.

In the case where a ball mill or a bead mill, the rotation number thereof may vary depending on the processing scale, and cannot be determined unconditionally, and the rotation number thereof is generally 10 rpm or more, preferably 20 rpm or more, and more preferably 50 rpm or more, and the upper limit thereof is generally 1,000 rpm or less, preferably 900 rpm or less, more preferably 800 rpm or less, and further preferably 700 rpm or less.

The pulverization time in this case may vary depending on the processing scale, and cannot be determined unconditionally, and the pulverization time is generally 0.5 hour or more, preferably 1 hour or more, more preferably 5 hours or more, and further preferably 10 hours or more, and the upper limit thereof is generally 100 hours or less, preferably 72 hours or less, more preferably 48 hours or less, and further preferably 36 hours or less.

The operation of mixing, agitation, pulverization, or a combination thereof can be performed, and the particle diameter and the like of the resulting sulfide can be regulated, by selecting the size and the material of the medium used (such as beads and balls), the rotation number of the rotor, the pulverization time, and the like.

### (Solvent)

In the mixing, the raw materials may be mixed with a solvent added thereto. The solvent used may be various solvents and the like widely referred to as an organic solvent.

The solvent used may be a solvent that has been used in the production of solid electrolytes, and examples thereof include a hydrocarbon solvent, such as an aliphatic hydrocarbon solvent, an alicyclic hydrocarbon solvent, and an aromatic hydrocarbon solvent.

Examples of the aliphatic hydrocarbon include hexane, pentane, 2-ethylhexane, heptane, octane, decane, undecane, dodecane, and tridecane, examples of the alicyclic hydrocarbon include cyclohexane and methylcyclohexane, and examples of the aromatic hydrocarbon solvent include benzene, toluene, xylene, mesitylene, ethylbenzene, tert-butylbenzene, trifluoromethylbenzene, and nitrobenzene.

In addition to the hydrocarbon solvents described above, examples of the solvent also include a solvent containing an atom other than a carbon atom and a hydrogen atom, i.e., a hetero atom, such as a nitrogen atom, an oxygen atom, a sulfur atom, and a halogen atom. The solvent of this type has a capability of easily forming a complex with the compounds containing a lithium atom, a phosphorus atom, a sulfur atom, and a halogen atom used as the raw material (hereinafter the solvent of this type may be referred to as a “complexing agent”), and a capability of retaining a halogen atom inside the structure of the sulfide solid electrolyte, and therefore is useful for providing the higher ionic conductivity. Preferred examples of the complexing agent include an ether solvent and an ester solvent, and also include an alcohol solvent, an aldehyde solvent, and a ketone solvent, which contain an oxygen atom as a hetero atom.

Preferred examples of the ether solvent include an aliphatic ether, such as dimethyl ether, diethyl ether, tert-butyl methyl ether, dimethoxymethane, dimethoxyethane, diethylene glycol dimethyl ether (diglyme), triethylene glycol dimethyl ether (triglyme), diethylene glycol, and triethylene glycol; an alicyclic ether, such as ethylene oxide, propylene oxide, tetrahydrofuran, tetrahydropyran, dimethoxytetrahydrofuran, cyclopentyl methyl ether, and dioxane; a heterocyclic ether, such as furan, benzofuran, and benzopyran; and an aromatic ether, such as methyl phenyl ether (anisole), ethyl phenyl ether, dibenzyl ether, and diphenyl ether.

Preferred examples of the ester solvent include an aliphatic ester, such as methyl formate, ethyl formate, methyl acetate, ethyl acetate, propyl acetate, isopropyl acetate, methyl propanoate, ethyl propanoate, dimethyl oxalate, diethyl oxalate, dimethyl malonate, diethyl malonate, dimethyl succinate, and diethyl succinate; an alicyclic ester, such as methyl cyclohexanecarboxylate, ethyl cyclohexanecarboxylate, and dimethyl cyclohexanedicarboxylate; a heterocyclic ester, such as methyl pyridinecarboxylate, methyl pyrimidinecarboxylate, acetolactone, propiolactone, butyrolactone, and valerolactone; and an aromatic ester, such as methyl benzoate, ethyl benzoate, dimethyl phthalate, diethyl phthalate, butyl benzyl phthalate, dicyclohexyl phthalate, trimethyl trimellitate, and triethyl trimellitate. Preferred examples thereof also include an alcohol solvent, such as ethanol and butanol; an aldehyde solvent, such as formaldehyde, acetaldehyde, and dimethylformamide; and a ketone solvent, such as acetone and methyl ethyl ketone.

Examples of the solvent containing a nitrogen atom as a hetero atom include a solvent having a group containing a nitrogen atom, such as an amino group, an amide group, a nitro group, and a nitrile group.

Preferred examples of the solvent having an amino group include an aliphatic amine, such as ethylenediamine, diaminopropane, dimethylethylenediamine, diethylethylenediamine, dimethyldiaminopropane, tetramethyldiaminomethane, tetramethylethylenediamine (TMEDA), tetramethyldiaminopropane (TMPDA); an alicyclic amine, such as cyclopropanediamine, cyclohexanediamine, and bisaminomethylcyclohexane; a heterocyclic amine, such as isophorone diamine, piperazine, dipiperidylpropane, and dimethylpiperazine; and an aromatic amine, such as phenylenediamine, tolylenediamine, naphthalenediamine, methylphenylenediamine, dimethylnaphthalenediamine, dimethylphenylenediamine, tetramethylphenylenediamine, and tetramethylnaphthalenediamine.

Preferred examples thereof also include a nitrile solvent, such as acetonitrile and acrylonitrile; and a solvent containing a nitrogen atom, such as dimethylformamide, nitrobenzene, and dimethylacetamide.

Preferred examples of the solvent containing a halogen atom as a hetero atom include chloroform, carbon tetrachloride, dichloromethane, chlorobenzene, dichlorobenzene, trifluoromethylbenzene, chlorotoluene, and bromobenzene.

Preferred examples of the solvent containing a sulfur atom include dimethylsulfoxide and carbon disulfide.

In the case where the solvent is used, the amount of the solvent used is preferably 100 mL or more, more preferably 200 mL or more, further preferably 250 mL or more, and still further preferably 300 mL or more, and the upper limit thereof is preferably 3,000 mL or less, more preferably 2,500 mL or less, further preferably 2,000 mL or less, and still further preferably 1,550 mL or less, per 1 kg in total of the amounts of the raw materials. In the case where the amount of the solvent used is in the range, the raw materials can be reacted efficiently.

### (Drying)

In the case where the mixing is performed with a solvent, the fluid (which is generally a slurry) obtained by mixing may be dried after mixing. A sulfide solid electrolyte can be obtained by removing the complexing agent from the complex containing the complexing agent in the case where the complexing agent is used as a solvent, by removing the complexing agent and removing the solvent from the complex containing the complexing agent in the case where the complexing agent and the solvent are used in combination, or by removing the solvent in the case where the solvent other than the complexing agent is used. The resulting sulfide solid electrolyte exhibits an ionic conductivity derived from a lithium atom.

The drying of the fluid obtained by mixing may be performed at a temperature corresponding to the kind of the solvent, for example, a temperature of the boiling point of the complexing agent or more.

The drying can be performed by evaporating the complexing agent and the solvent used depending on necessity through reduced pressure drying (vacuum drying) with a vacuum pump or the like at generally 5 to 100° C., preferably 10 to 85° C., more preferably 15 to 70° C., and further preferably around room temperature (23° C.) (for example, room temperature ±5° C.).

The drying of the fluid may also be performed through filtration with a glass filter or the like, solid-liquid separation by decantation, or solid-liquid separation with a centrifugal separator. In the case where the solvent other than the complexing agent is used, the sulfide solid electrolyte can be obtained through solid-liquid separation. In the case where the complexing agent is used as the solvent, it suffices that solid-liquid separation is performed, and then the drying is performed under the temperature condition above for removing the complexing agent entrained in the complex.

Specifically, the solid-liquid separation can be easily performed by decantation in which the fluid is transferred to a vessel, and after settling the sulfide (or the complex (which may also be referred to as a precursor of the sulfide solid electrolyte) in the case containing the complexing agent), the complexing agent and the solvent as a supernatant are removed, by filtering using a glass filter having a pore size, for example, of approximately 10 to 200 μm, and preferably 20 to 150 μm.

The drying after mixing may be performed before the hydrogen treatment described later, or may be performed after performing the hydrogen treatment.

The sulfide solid electrolyte obtained through the mixing described above, or in the case where the solvent is used, the sulfide solid electrolyte obtained by removing the solvent through the drying described above exhibits an ionic conductivity derived from a lithium atom.

The sulfide solid electrolyte obtained through the mixing described above is basically an amorphous sulfide solid electrolyte (glass component) unless performing the mixing, for example, through pulverization with a pulverizer to an extent that causes crystallization.

The sulfide solid electrolyte obtained through the mixing above may be an amorphous sulfide solid electrolyte (glass component) or may be a crystalline sulfide solid electrolyte, which may be appropriately selected depending on desire. In the case where a crystalline sulfide solid electrolyte is to be produced, a crystalline sulfide solid electrolyte can be formed by heating the amorphous sulfide solid electrolyte obtained by mixing as described above.

The sulfide solid electrolyte may contain a crystalline sulfide solid electrolyte having formed on the surface thereof an amorphous component (glass component), which is obtained as a result, for example, of the treatment described later, such as pulverization, performed for regulating the particle diameter of powder of the crystalline sulfide solid electrolyte. Therefore, the sulfide solid electrolyte containing an amorphous component encompasses an amorphous sulfide solid electrolyte, and a sulfide solid electrolyte containing a crystalline sulfide solid electrolyte having formed on the surface thereof an amorphous component.

### (Heating)

The production of the crystalline sulfide solid electrolyte may further include heating. In the case where an amorphous sulfide solid electrolyte (glass component) is obtained by mixing as described above, the crystalline sulfide solid electrolyte can be obtained by heating, and in the case where a crystalline sulfide solid electrolyte is obtained thereby, a crystalline sulfide solid electrolyte having an increased crystallinity can be obtained by heating.

In the case where a complexing agent is used as the solvent in mixing, a complex containing the complexing agent is formed, and a sulfide solid electrolyte can be obtained by removing the complexing agent by heating without the drying described above, in which either the amorphous sulfide solid electrolyte or the crystalline sulfide solid electrolyte can be obtained depending on the heating condition.

As for the heating temperature, for example, in the case where an amorphous sulfide solid electrolyte is obtained, the heating temperature may be determined depending on the structure of the crystalline sulfide solid electrolyte obtained by heating the amorphous sulfide solid electrolyte, and specifically, can be determined in such a manner that the amorphous sulfide solid electrolyte is subjected to differential thermal analysis (DTA) under a temperature rise condition of 10° C./min with a differential thermal analyzer (DTA device), in which based on the peak top temperature of the exothermic peak observed on the lowest temperature side, the heating temperature is preferably in a range of a temperature lower by 5° C. or less, more preferably a temperature lower by 10° C. or less, and further preferably a temperature lower by 20° C. or less, and the lower limit thereof is not particularly limited, and may be approximately a temperature lower by −40° C. than the peak top temperature of the exothermic peak observed on the lowest temperature side or more. Within the temperature range, the amorphous sulfide solid electrolyte can be obtained more efficiently and securely. The heating temperature for providing the amorphous sulfide solid electrolyte may vary depending on the structure of the crystalline sulfide solid electrolyte to be obtained, and cannot be determined unconditionally, and in general, the heating temperature is preferably 135° C. or less, more preferably 130° C. or less, and further preferably 125° C. or less, and the lower limit thereof is not particularly limited and is preferably 90° C. or more, more preferably 100° C. or more, and further preferably 105° C. or more.

In the case where a crystalline sulfide solid electrolyte is obtained by heating an amorphous sulfide solid electrolyte, the heating temperature may be determined depending on the structure of the crystalline sulfide solid electrolyte, and is preferably a temperature higher than the heating temperature for providing the amorphous sulfide solid electrolyte described above, and specifically, the heating temperature can be determined in such a manner that the amorphous sulfide solid electrolyte is subjected to differential thermal analysis (DTA) under a temperature rise condition of 10° C./min with a differential thermal analyzer (DTA device), in which based on the peak top temperature of the exothermic peak observed on the lowest temperature side, the heating temperature is preferably in a range of a temperature higher by 5° C. or more, more preferably a temperature higher by 10° C. or more, and further preferably a temperature higher by 20° C. or more, and the upper limit thereof is not particularly limited, and may be approximately a temperature higher by 40° C. than the peak top temperature of the exothermic peak observed on the lowest temperature side or less. Within the temperature range, the crystalline sulfide solid electrolyte can be obtained more efficiently and securely. The heating temperature for providing the crystalline sulfide solid electrolyte may vary depending on the composition and the structure of the crystalline sulfide solid electrolyte to be obtained, and cannot be determined unconditionally, and in general, the heating temperature is preferably 130° C. or more, more preferably 135° C. or more, and further preferably 140° C. or more, and the upper limit thereof is not particularly limited and is preferably 600° C. or less, more preferably 550° C. or less, and further preferably 500° C. or less.

The heating time is not particularly limited, as long as being the time capable of providing the amorphous sulfide solid electrolyte or the crystalline sulfide solid electrolyte to be obtained, and for example, is preferably 1 minute or more, more preferably 10 minutes or more, further preferably 30 minutes or more, and still further preferably 1 hour or more. The upper limit of the heating time is not particularly limited, and is preferably 24 hours or less, more preferably 10 hours or less, further preferably 5 hours or less, and still further preferably 3 hours or less.

The heating is preferably performed in an inert gas atmosphere (such as a nitrogen atmosphere and an argon atmosphere or a reduced pressure atmosphere (particularly in vacuum), which may also be an inert gas atmosphere containing a certain concentration of hydrogen. The crystalline sulfide solid electrolyte thereby can be prevented from being deteriorated (for example, oxidized).

The heating method is not particularly limited, and examples thereof include a method using a hot plate, a vacuum heating device, an argon gas atmosphere furnace, or a baking furnace. In the industrial production, a horizontal dryer, a horizontal vibration fluid dryer, or the like having a heating unit and a conveying mechanism may also be used, which can be selected depending on the processing amount to be heated.

### (Sulfide Solid Electrolyte)

The sulfide solid electrolyte used in the present embodiment may be a commercially available product or a produced product as described above.

The sulfide solid electrolyte obtained by the method described above is an amorphous (glass component) or crystalline sulfide solid electrolyte containing a lithium atom, a sulfur atom, a phosphorus atom, and a halogen atom, and can be preferably used as the sulfide solid electrolyte in the present embodiment.

### (BET Specific Surface Area)

The sulfide solid electrolyte used in the present embodiment has a BET specific surface area of 10 m²/g or more. The modified sulfide solid electrolyte of the present embodiment has an effect of exhibiting the excellent coating suitability in coating as a paste and exhibiting the excellent battery capabilities efficiently irrespective of such a large specific surface area, and the higher the BET specific surface area is, the more advantageous the effect can be. From this standpoint, the BET specific surface area is preferably 12 m²/g or more, more preferably 15 m²/g or more, and further preferably 20 m²/g or more. From the same standpoint, the upper limit thereof is not particularly limited, and is practically 100 m²/g or less, preferably 75 m²/g or less, and more preferably 50 m²/g or less.

In the description herein, the BET specific surface area is a specific surface area that is measured according to JIS Z8830:2013 (Determination of the specific surface area of powders (solids) by gas adsorption) using krypton as an adsorbate.

### (Amorphous Sulfide Solid Electrolyte)

The amorphous sulfide solid electrolyte obtained by the method described above contains a lithium atom, a sulfur atom, a phosphorus atom, and a halogen atom, and representative preferred examples thereof include a solid electrolyte constituted by lithium sulfide, phosphorus sulfide, and a lithium halide, such as Li₂S—P₂S₅—LiI, Li₂S—P₂S₅—LiCl, Li₂S—P₂S₅—LiBr, and Li₂S—P₂S₅—LiI—LiBr; and a solid electrolyte further containing other atoms, such as an oxygen atom and a silicon atom, such as Li₂S—P₂S₅—Li₂O—LiI and Li₂S—SiS₂—P₂S₅—LiI. Preferred examples thereof include a solid electrolyte constituted by lithium sulfide, phosphorus sulfide, and a lithium halide, such as Li₂S—P₂S₅—LiI, Li₂S—P₂S₅—LiCl, Li₂S—P₂S₅—LiBr, and Li₂S—P₂S₅—LiI—LiBr, from the standpoint of providing the higher ionic conductivity. The kinds of atoms constituting the amorphous sulfide solid electrolyte can be confirmed, for example, with an inductively coupled plasma (ICP) light emission spectroscope. The shape of the amorphous sulfide solid electrolyte is not particularly limited, and examples thereof include a particle shape. Examples of the average particle diameter (D₅₀) of the amorphous sulfide solid electrolyte having a particle shape include a range of 0.01 μm to 500 μm, or 0.1 to 200 μm.

### (Crystalline Sulfide Solid Electrolyte)

The crystalline sulfide solid electrolyte obtained by the method described above may be so-called glass ceramics obtained by heating the amorphous sulfide solid electrolyte to the crystallization temperature or more, and examples of the crystal structure thereof include an Li₃PS₄ crystal structure, an Li₄P₂S₆ crystal structure, an Li₂PS₆ crystal structure, an Li₂P₃S₁₁ crystal structure, and a crystal structure having peaks around 2θ=20.2° and 23.6° (see, for example, JP 2013-16423 A).

Examples thereof also include an Li₄₊ₓGe₁₋ₓPₓS₄ based thio-LISICON Region II type crystal structure (see Kanno, et al., Journal of The Electrochemical Society, 148 (7) A742-746 (2001)) and a crystal structure similar to the Li₄₊ₓGe₁₋ₓPₓS₄ based thio-LISICON Region II type crystal structure (see Solid State Ionics, 177 (2006), 2721-2725). The crystal structure of the crystalline sulfide solid electrolyte obtained by the production method of the present embodiment is preferably the thio-LISICON Region II type crystal structure among the above from the standpoint of providing the higher ionic conductivity. The “thio-LISICON Region II type crystal structure” herein means any of the Li₄₋ₓGe₁₋ₓPₓS₄ based thio-LISICON Region II type crystal structure and the crystal structure similar to the Li₄₊ₓGe₁₋ₓPₓS₄ based thio-LISICON Region II type crystal structure. The crystal structure of the crystalline sulfide solid electrolyte obtained by the production method of the present embodiment may have the thio-LISICON Region II type crystal structure, or may have the crystal structure as a main crystal phase, and preferably has the crystal structure as a main crystal phase from the standpoint of providing the higher ionic conductivity. In the description herein, the expression “having as a main crystal phase” means that the proportion of the target crystal structure in the entire crystal structure is 80% or more, preferably 90% or more, and more preferably 95% or more. The crystalline sulfide solid electrolyte obtained by the production method of the present embodiment preferably does not contain crystalline Li₃PS₄(β-Li₃PS₄) from the standpoint of providing the higher ionic conductivity.

In the X-ray diffractometry using CuKα line, the diffraction peaks of the Li₃PS₄ crystal structure appear, for example, around 2θ=17.5°, 18.3°, 26.1°, 27.3°, and 30.0°, the diffraction peaks of the Li₄P₂S₆ crystal structure appear, for example, around 2θ=16.9°, 27.1°, and 32.5°, the diffraction peaks of the Li₂PS₆ crystal structure appear, for example, around 2θ=15.3°, 25.2°, 29.6°, and 31.0°, the diffraction peaks of the Li₂P₃S₁₁ crystal structure appear, for example, around 2θ=17.8°, 18.5°, 19.7°, 21.8°, 23.7°, 25.9°, 29.6°, and 30.0°, the diffraction peaks of the Li₄₊ₓGe₁₋ₓPₓS₄ based thio-LISICON Region II type crystal structure appear, for example, around 2θ=20.1°, 23.9°, and 29.5°, and the diffraction peaks of the crystal structure similar to the Li₄₊ₓGe₁₋ₓPₓS₄ based thio-LISICON Region II type crystal structure appear, for example, around 2θ=20.2° and 23.6°. These peak positions may vary within a range of +0.5°.

In the case where the thio-LISICON Region II type crystal structure is obtained in the present embodiment, it is preferred that crystalline Li₃PS₄(β-Li₃PS₄) is not contained as described above. The sulfide solid electrolyte obtained by the production method of the present embodiment does not have diffraction peaks at 2θ=17.5° and 26.1° appearing for crystalline Li₃PS₄, or even though the sulfide solid electrolyte has the diffraction peaks, the peaks are extremely smaller than the diffraction peaks of the thio-LISICON Region II type crystal structure.

The crystal structure having the Li—PS₆ structural skeleton in which a part of P is replaced by Si represented by the compositional formulae Li₂₋ₓP_{1-y}Si_{y}S₆ and Li₇₋ₓP_{1-y}Si_{y}S₆ (in which x represents −0.6 to 0.6, and y represents 0.1 to 0.6) is a cubic crystal or an orthorhombic crystal, and preferably a cubic crystal, and in the X-ray diffractometry using CuKα line, has peaks appearing mainly at 2θ=15.5°, 18.0°, 25.0°, 30.0°, 31.4°, 45.3°, 47.0°, and 52.0°. The crystal structure represented by the compositional formula Li_{7-x-2y}PS_{6-x-y}Clₓ (in which 0.8≤x≤1.7, and 0<y≤−0.25x+0.5) is preferably a cubic crystal, and in the X-ray diffractometry using CuKα line, has peaks appearing mainly at 2θ=15.5°, 18.0°, 25.0°, 30.0°, 31.4°, 45.3°, 47.0°, and 52.0°. The crystal structure represented by the compositional formula Li₂₋ₓPS₆₋ₓHaₓ (in which Ha represents Cl or Br, and x preferably represents 0.2 to 1.8) is preferably a cubic crystal, and in the X-ray diffractometry using CuKα line, has peaks appearing mainly at 2θ=15.5°, 18.0°, 25.0°, 30.0°, 31.4°, 45.3°, 47.0°, and 52.0°. These crystal structures basically having the Li₂PS₆ structural skeleton are also referred to as an argyrodite type crystal structure.

These peak positions may vary within a range of +0.5°.

The shape of the crystalline sulfide solid electrolyte is not particularly limited, and examples thereof include a particle shape. Examples of the average particle diameter (D₅₀) of the crystalline sulfide solid electrolyte having a particle shape include a range of 0.01 μm to 500 μm, or 0.1 to 200 μm.

### (Properties of Modified Sulfide Solid Electrolyte)

The modified sulfide solid electrolyte of the present embodiment has a BET specific surface area of 10 m²/g or more, i.e., has a large specific surface area, as similar to the sulfide solid electrolyte used. The BET specific surface area is preferably 12 m²/g or more, more preferably 15 m²/g or more, and further preferably 20 m²/g or more, from the standpoint of the fact that the higher the BET specific surface area is, the more advantageous the effect can be. From the same standpoint, the upper limit thereof is not particularly limited, and is practically 100 m²/g or less, preferably 75 m²/g or less, and more preferably 50 m²/g or less.

The attachment of a lithium halide to the sulfide solid electrolyte does not largely influence the BET specific surface area thereof, and the BET specific surface area of the sulfide solid electrolyte used in the present embodiment and the BET specific surface area of the modified sulfide solid electrolyte are substantially the same as each other. Therefore, the use of the sulfide solid electrolyte having a BET specific surface area of 10 m²/g or more can naturally provide the modified sulfide solid electrolyte having a BET specific surface area of 10 m²/g or more, as described above.

The oil absorption of the modified sulfide solid electrolyte of the present embodiment is reduced due to the effect of the compounds (1) to (6) attached to the surface thereof generally to 1.10 mL/g or less, and furthermore to 1.00 mL/g or less, 0.90 mL/g or less, 0.85 mL/g or less, or 0.80 mL/g or less, irrespective of the large BET specific surface area thereof described above. The modified sulfide solid electrolyte of the present embodiment has a small oil absorption irrespective of the large BET specific surface area thereof, and thereby the paste thereof can be suppressed in increase of the viscosity of the paste, the excellent coating suitability can be obtained in coating, and the excellent battery capabilities can be easily obtained since a solvent or the like is not necessarily used for preventing the increase of the viscosity of the paste.

In the description herein, the oil absorption is measured in such a manner that one drop of butyl butyrate is added to 1 g of the modified sulfide solid electrolyte as a specimen in a mortar or the like, and agitated with a spatula, and the operation is repeated until the specimen becomes a paste form, at which the total amount of butyl butyrate is designated as an oil absorption (mL/g). The “paste form” herein means such a state that “the specimen can be spread without cracking or crumbling, and can be lightly attached to the measuring plate” defined in JIS K5101-13-1:2004 (Test methods for pigments, Part 13: Oil absorption, Section 1: Refined linseed oil method), Section 7.2 Measurement.

The ionic conductivity of the modified sulfide solid electrolyte of the present embodiment is generally 0.5 mS/cm or more, and furthermore 1.0 mS/cm or more, 1.5 mS/cm or more, 2.0 mS/cm or more, or 2.5 mS/cm or more, i.e., an extremely high ionic conductivity, resulting in a lithium battery having the excellent battery capabilities.

### (Applications)

The modified sulfide solid electrolyte of the present embodiment is excellent in coating suitability, and can be applied to the production of batteries without the use of a solvent or the like, and therefore the excellent battery capabilities can be exhibited efficiently. Furthermore, the modified sulfide solid electrolyte has a high ionic conductivity and the excellent battery capabilities, and therefore can be favorably applied to batteries.

The modified sulfide solid electrolyte of the present embodiment can be used in a positive electrode layer, can be used in a negative electrode layer, and may be used in an electrolyte layer. These layers can be produced according to the known method.

The battery preferably includes a collector, in addition to the positive electrode layer, the electrolyte layer, and the negative electrode layer, and the known collector may be used. Examples thereof used include a layer including a material that reacts with the solid electrolyte, such as Au, Pt, Al, Ti, or Cu, covered with Au or the like.

### [Method of Producing Modified Sulfide Solid Electrolyte]

The method of producing a modified sulfide solid electrolyte of the present embodiment is a production method including
mixing a sulfide solid electrolyte having a BET specific surface area of 10 m²/g or more and containing a lithium atom, a sulfur atom, a phosphorus atom, and a halogen atom, at least one compound selected from the following compounds (1) to (6), and an organic solvent, and
removing the organic solvent.

The production method of the present embodiment can efficiently produce the modified sulfide solid electrolyte of the present embodiment. In other words, the modified sulfide solid electrolyte of the present embodiment is preferably produced by the production method of the present embodiment.
Compound (1): a compound having a formyl group (CH(═O)—)
Compound (2): a compound having one or more acetyl group (CH₃C(═O)—)
Compound (3): a compound having two or more halogen-containing groups represented by —CH₂X (in which X represents a fluorine atom, a chlorine atom, a bromine atom, or an iodine atom) and an organic group
Compound (4): a thiol compound
Compound (5): a metal-free phosphorus compound (provided that the compound does not contain an oxygen atom that is bonded to a phosphorus atom via a single bond)
Compound (6): a metal-free boron compound

In the compound having two or more halogen-containing groups represented by —CH₂X (in which X represents a fluorine atom, a chlorine atom, a bromine atom, or an iodine atom) and an organic group as the compound (3), the halogen atom represented by X is preferably a fluorine atom or a bromine atom.

The sulfide solid electrolyte having a BET specific surface area of 10 m²/g or more and containing a lithium atom, a sulfur atom, a phosphorus atom, and a halogen atom used in the production method of the present embodiment may be the same sulfide solid electrolyte as described for that can be used in the modified sulfide solid electrolyte of the present embodiment described above. Therefore, the sulfide solid electrolyte may be a commercially available product or a sulfide solid electrolyte produced by the method of producing the sulfide solid electrolyte described above.

Examples of the organic solvent used in the production method of the present embodiment include the solvents described for those that can be used in the method of producing the sulfide solid electrolyte described above. Among the solvents, preferred examples thereof include an aliphatic hydrocarbon solvent, an alicyclic hydrocarbon solvent, an aromatic hydrocarbon solvent, and an ether solvent, an ester solvent, and a nitrile solvent, which are exemplified as the complexing agent, in which an aromatic hydrocarbon solvent is more preferred, from the standpoint of promoting the mixing of the sulfide solid electrolyte and the heteropolycyclic compound, and providing the modified sulfide solid electrolyte containing the sulfide solid electrolyte and the heteropolycyclic compound efficiently, and the standpoint of promoting the attachment of the heteropolycyclic compound to the sulfide solid electrolyte.

In the production method of the present embodiment, one of the organic solvents may be used alone, or multiple kinds thereof may be used in combination.

In the production method of the present embodiment, the method of mixing the sulfide solid electrolyte, the heteropolycyclic compound, and the organic solvent can be performed in the same method as in the “mixing” in the method of producing the sulfide solid electrolyte described above.

The removal of the organic solvent can be performed in the same method as in the “drying” in the method of producing the sulfide solid electrolyte described above.

In the production method of the present embodiment, the “heating” in the method of producing the sulfide solid electrolyte described above can be performed.

### [Electrode Mixture]

The electrode mixture of the present embodiment is an electrode mixture containing the modified sulfide solid electrolyte according to the present embodiment, and an electrode active substance, and is an electrode mixture containing the modified sulfide solid electrolyte according to another embodiment, and an electrode active substance.

### (Electrode Active Substance)

The electrode active substance used is either a positive electrode active substance or a negative electrode active substance depending on whether the electrode mixture is used in a positive electrode or a negative electrode, respectively.

The positive electrode active substance used is not particularly limited, as long as being a material that is capable of promoting the cell chemical reaction associated with lithium ion migration caused by an atom that can be used as an atom exhibiting ionic conductivity in relation to the negative electrode active substance, preferably a lithium atom. Examples of the positive electrode active substance capable of performing intercalation and deintercalation of a lithium ion include an oxide based positive electrode active substance and a sulfide based positive electrode active substance.

Preferred examples of the oxide based positive electrode active substance include a lithium-containing transition metal complex oxide, such as LMO (lithium manganese oxide), LCO (lithium cobalt oxide), NMC (lithium nickel cobalt manganese oxide), NCA (lithium nickel cobalt aluminum oxide), LNCO (lithium nickel cobalt oxide), and an olivine type compound (LiMeNPO₄, in which Me=Fe, Co, Ni, or Mn).

Examples of the sulfide based positive electrode active substance include titanium sulfide (TiS₂), molybdenum sulfide (MoS₂), iron sulfide (FeS, FeS₂), copper sulfide (CuS), and nickel sulfide (Ni₃S₂).

In addition to the positive electrode active substances described above, niobium selenide (NbSe₃) and the like can also be used.

One kind of the positive electrode active substance may be used alone, or multiple kinds thereof may be used in combination.

The negative electrode active substance used is not particularly limited, as long as being a material that is capable of promoting the cell chemical reaction associated with lithium ion migration caused preferably by a lithium atom, such as a metal that is capable of forming an alloy with an atom that can be used as an atom exhibiting ionic conductivity in relation to the negative electrode active substance, preferably a lithium atom, an oxide thereof, and an alloy of the metal and a lithium atom. The negative electrode active substance capable of performing intercalation and deintercalation of a lithium ion used may be any negative electrode active substance known in the field of batteries with no particular limitation.

Examples of the negative electrode active substance include metallic lithium or a metal capable of forming an alloy with metallic lithium, such as metallic lithium, metallic indium, metallic aluminum, metallic silicon, and metallic tin, an oxide of the metal, and an alloy of the metal and metallic lithium.

The electrode active substance used in the present embodiment may have a surface coated with a coating layer.

Preferred examples of the material for forming the coating layer include an ionic conductor, such as a nitride, an oxide, or a composite thereof, of an atom exhibiting ionic conductivity in the sulfide solid electrolyte, preferably a lithium atom. Specific examples thereof include a conductor having lithium nitride (Li₃N) or Li₄GeO₄ as the major structure, for example, a silicon type crystal structure, such as Li₄₋₂ₓZnₓGeO₄, a conductor having an Li₃PO₄ type skeleton structure, for example, a thiosilicon type crystal structure, such as Li₄₋ₓGe₁₋ₓPₓS₄, a conductor having a perovskite type crystal structure, such as La_{2/3-x}Li₃ₓTiO₃, and a conductor having a NASICON type crystal structure, such as LiTi₂(PO₄)₃.

Examples thereof also include lithium titanate, such as Li_{y}Ti_{3-y}O₄ (0<y<3) and Li₄Ti₅O₁₂ (LTO), a sodium metalate of a metal belonging to Group 5 of Periodic Table, such as LiNbO₃ and LiTaO₃, and an oxide based conductor, such as an Li₂O—B₂O₃—P₂O₅ based conductor, an Li₂O—B₂O₃—ZnO based conductor, and an Li₂O—Al₂O₃—SiO₂—P₂O₅—TiO₂ based conductor.

The electrode active substance having a coating layer can be obtained, for example, in such a manner that a solution containing atoms constituting the material for forming the coating layer is attached to the surface of the electrode active substance, and the electrode active substance having the solution attached thereto is then baked preferably at 200° C. or more and 400° C. or less.

The solution containing atoms used herein may be a solution containing an alkoxide of metals, such as lithium ethoxide, titanium isopropoxide, niobium isopropoxide, and tantalum isopropoxide. In this case, the solvent used may be an alcohol based solvent, such as ethanol and butanol; an aliphatic hydrocarbon solvent, such as hexane, heptane, and octane; an aromatic hydrocarbon solvent, such as benzene, toluene, and xylene; and the like.

The solution can be attached through immersion, spray coating, or the like.

The baking temperature is preferably 200° C. or more and 400° C. or less as described above, and more preferably 250° C. or more and 390° C. or less, from the standpoint of enhancing the production efficiency and the battery capabilities, and the baking time is generally approximately 1 minute to 10 hours, and preferably 10 minutes to 4 hours.

The coverage of the coating layer is preferably 90% or more, more preferably 95% or more, and further preferably 100%, based on the surface area of the electrode active substance, i.e., the entire surface thereof is coated. The thickness of the coating layer is preferably 1 nm or more, and more preferably 2 nm or more, and the upper limit thereof is preferably 30 nm or less, and more preferably 25 nm or less.

The thickness of the coating layer can be measured through cross sectional observation with a transmission electron microscope (TEM), and the coverage can be calculated from the thickness of the coating layer, the elemental analysis values, and the BET specific surface area.

### (Additional Components)

The electrode mixture of the present embodiment may contain an additional component, such as a conducting material and a binder, in addition to the modified sulfide solid electrolyte and the electrode active substance described above. Accordingly, in the electrode mixture of the present embodiment, an additional component, such as a conducting material and a binder, may be used in addition to the modified sulfide solid electrolyte and the electrode active substance described above. The additional component, such as a conducting material and a binder, may be used by adding to and mixing with the modified sulfide solid electrolyte and the electrode active substance, in mixing the modified sulfide solid electrolyte and the electrode active substance.

Examples of the conducting material include a carbonaceous material, such as artificial graphite, graphite carbon fibers, resin fired carbon, thermal decomposition vapor phase grown carbon, coke, mesocarbon microbeads, furfuryl alcohol resin fired carbon, polyacene, pitch based carbon fibers, vapor phase grown carbon fibers, natural graphite, and non-graphitizable carbon, from the standpoint of enhancing the battery capabilities by enhancing the electron conductivity.

The use of the binder enhances the strength in the case where a positive electrode or a negative electrode is produced.

The binder is not particularly limited, as long as being capable of imparting the capabilities, such as bindability and flexibility, and examples thereof include a fluorine based polymer, such as polytetrafluoroethylene and polyvinylidene fluoride, a thermoplastic elastomer, such as butylene rubber and styrene-butadiene rubber, and a resin, such as an acrylic resin, an acrylic polyol resin, a polyvinylacetal resin, a polyvinylbutyral resin, and a silicone resin.

The mixing ratio (mass ratio) of the electrode active substance and the modified sulfide solid electrolyte in the electrode mixture is preferably 99.5/0.5 to 40/60, more preferably 99/1 to 50/50, and further preferably 98/2 to 60/40, in consideration of the enhancement of the battery capabilities and the production efficiency.

In the case where the conductive material is contained, the content of the conductive material in the electrode mixture is not particularly limited, and is preferably 0.5% by mass or more, more preferably 1% by mass or more, and further preferably 1.5% by mass or more, and the upper limit thereof is preferably 10% by mass or less, more preferably 8% by mass or less, and further preferably 5% by mass or less, in consideration of the enhancement of the battery capabilities and the production efficiency.

In the case where the binder is contained, the content of the binder in the electrode mixture is not particularly limited, and is preferably 1% by mass or more, more preferably 3% by mass or more, and further preferably 5% by mass or more, and the upper limit thereof is preferably 20% by mass or less, more preferably 15% by mass or less, and further preferably 10% by mass or less, in consideration of the enhancement of the battery capabilities and the production efficiency.

### [Lithium Ion Battery]

The lithium ion battery of the present embodiment is a lithium ion battery including at least one of the modified sulfide solid electrolyte and the electrode mixture according to the present embodiment, or including at least one of the modified sulfide solid electrolyte and the electrode mixture according to another embodiment.

The lithium ion battery of the present embodiment is not particularly limited in configuration thereof, and may have a configuration of an ordinary lithium ion battery, as long as including the modified sulfide solid electrolyte of the present embodiment or an electrode mixture containing the same, or including the modified sulfide solid electrolyte of another embodiment or an electrode mixture containing the same.

The lithium ion battery of the present embodiment preferably includes, for example, a positive electrode layer, a negative electrode layer, an electrolyte layer, and a collector. The positive electrode layer and the negative electrode layer each preferably use the electrode mixture of the present embodiment, and the electrolyte layer preferably uses the modified sulfide solid electrolyte of the present embodiment or the modified sulfide solid electrolyte of another embodiment.

The collector used may be the known material. Examples thereof used include a layer including a material that reacts with the solid electrolyte, such as Au, Pt, Al, Ti, or Cu, covered with Au or the like.

### EXAMPLES

The present invention will be described specifically with reference to examples below, but the present invention is not limited to the examples.

### Production Example: Production of Sulfide Solid Electrolyte

Under a nitrogen atmosphere, 0.59 g of lithium sulfide, 0.95 g of diphosphorus pentasulfide, 0.19 g of lithium bromide, and 0.28 g of lithium iodide were placed in a Schlenk flask (capacity: 100 mL) having a stirring bar inside. After rotating the stirring bar, 20 mL of tetramethylethylenediamine (TMEDA) as a complexing agent was added thereto, followed by continuously agitating for 12 hours, and the resulting material containing a complex was dried in vacuum (room temperature: 23° C.) to provide a complex in a powder form. Subsequently, the complex in a powder form was heated at 120° C. in vacuum for 2 hours to provide an amorphous sulfide solid electrolyte. The amorphous sulfide solid electrolyte was further heated to 140° C. in vacuum for 2 hours to provide a crystalline sulfide solid electrolyte 1 (the heating temperature for providing the crystalline sulfide solid electrolyte (which is 140° C. in this example) may also be referred to as a “crystallization temperature”).

The BET specific surface areas of the amorphous sulfide solid electrolyte and the crystalline sulfide solid electrolyte thus obtained were measured and were both 40 m²/g.

### Example 1

Under a nitrogen atmosphere, 3 g of the crystalline sulfide solid electrolyte produced in Production Example above was weighed and placed in a Schlenk flask (capacity: 100 mL) having a stirring bar inside, to which 22 g of toluene was added, and the mixture was agitated to provide a fluid in a slurry form. To the fluid in a slurry form, heptanal (compound 1, represented by the general formula (1), in which R¹¹ and X₁₁ represent single bonds, n₁₁ represents 0, and R¹² represents a hexyl group) as the compound (1) having a formyl group (CH(═O)—) was added in an amount of 0.3 g (i.e., 10 parts by mass as 10% by mass per 100 parts by mass of the crystalline sulfide solid electrolyte), and after agitating for 10 minutes, toluene was distilled off through vacuum drying to provide a modified sulfide solid electrolyte.

The resulting modified sulfide solid electrolyte was measured for the oil absorption and the ionic conductivity by the following methods. The reduction rate of the oil absorption was calculated by the following method. The measurement results and the calculation result are shown in Table 1.

### Examples 2 to 22

A modified sulfide solid electrolyte was produced in the same manner as in Example 1 except that in Example 1, the kind of the compound was changed to the compounds 2 to 19 and 23 to 25 shown in Table 1.

The resulting modified sulfide solid electrolyte was measured for the oil absorption and the ionic conductivity by the following methods. The reduction rate of the oil absorption was calculated by the following method. The measurement results and the calculation result are shown in Table 1.

### Comparative Examples 1 to 3

A modified sulfide solid electrolyte was produced in the same manner as in Example 1 except that in Example 1, the kind of the compound was changed to the compounds 20 to 22 shown in Table 1.

The resulting modified sulfide solid electrolyte was measured for the oil absorption and the ionic conductivity by the following methods. The reduction rate of the oil absorption was calculated by the following method. The measurement results and the calculation result are shown in Table 1.

### Comparative Example 4

The sulfide solid electrolyte obtained in the Production Example above was measured for the oil absorption and the ionic conductivity by the following methods. The reduction rate of the oil absorption was calculated by the following method. The measurement results and the calculation result are shown in Table 1. The oil absorption of the sulfide solid electrolyte was 1.03 mL/g.

### (Measurement of Specific Surface Area)

The specific surface area was measured by the BET method through krypton (Kr) adsorption with a gas adsorption amount measurement device.

### (Measurement of Oil Absorption)

One drop of butyl butyrate was added to 1 g of the sulfide solid electrolyte obtained in each of Examples and Comparative Examples as a specimen in a mortar, and agitated with a spatula, and the operation was repeated until the specimen became a paste form, at which the total amount of butyl butyrate was designated as an oil absorption (mL/g).

### (Reduction Rate of Oil Absorption)

The oil absorption of the sulfide solid electrolyte obtained in Production Example was measured in the same manner as above (Measurement of Oil Absorption). The value obtained by calculating by the following expression using the oil absorption A of the sulfide solid electrolyte and the oil absorption B of the sulfide solid electrolyte obtained in each of Examples and Comparative Examples by the above (Measurement of Oil Absorption) was designated as the reduction rate of the oil absorption.

$$Reduction rate of oil absorption ( \% ) = ( ( oil absorption A - oil absorption B ) / oil absorption A ) \times 100$$

### (Measurement of Ionic Conductivity)

In the examples, the ionic conductivity was measured in the following manner.

A circular pellet having a diameter of 10 mm (cross sectional area S: 0.785 cm²) and a height (L) of 0.1 to 0.3 cm was molded from the sulfide solid electrolyte to provide a specimen. Electrode terminals were attached to the upper and lower surfaces of the specimen, which was then measured by the alternating current impedance method (frequency range: 1 MHz to 100 Hz, amplitude: 10 mV) at 25° C. to provide a Cole-Cole plot. On the right side of the circular arc observed on the high frequency range region thereof, the real part Z′ (Ω) at the point making —Z″ (Ω) minimum was designated as the bulk resistance R (Ω) of the electrolyte, and the ionic conductivity σ (S/cm) was calculated according to the following expressions.

$$R = ρ ( L / S )$$

$$σ = 1 / ρ$$

TABLE 1

| | | | | Specific | | | | Reduction | |
|---|---|---|---|---|---|---|---|---|---|
| | | | | surface | | Content | Oil | rate of oil | Ion |
| | | | | area | Molecular | % by | absorption | absorption | conductivity |
| | | Compound | | m²/g | weight | mass | mL/g | % | mS/cm |
| Example | 1 | 1 | Compound (1) | 40 | 114.19 | 10 | 0.68 | 34% | 1.8 |
| | 2 | 2 | Compound (1) | 40 | 170.30 | 10 | 0.66 | 36% | 2.3 |
| | 3 | 3 | Compound (1) | 40 | 150.18 | 10 | 0.73 | 29% | 1.2 |
| | 4 | 4 | Compound (2) | 40 | 100.12 | 10 | 0.83 | 19% | 0.8 |
| | 5 | 5 | Compound (3) | 40 | 174.19 | 10 | 0.87 | 16% | 3.7 |
| | 6 | 6 | Compound (3) | 40 | 202.25 | 10 | 0.80 | 22% | 2.9 |
| | 7 | 7 | Compound (3) | 40 | 230.30 | 10 | 0.90 | 13% | 2.4 |
| | 8 | 8 | Compound (3) | 40 | 216.28 | 10 | 0.81 | 21% | 1.9 |
| | 9 | 9 | Compound (4) | 40 | 202.40 | 10 | 0.64 | 38% | 3.3 |
| | 10 | 10 | Compound (4) | 40 | 206.41 | 10 | 0.80 | 22% | 2.9 |
| | 11 | 11 | Compound (4) | 40 | 196.34 | 10 | 0.96 | 7% | 2.8 |
| | 12 | 12 | Compound (5) | 40 | 386.64 | 10 | 0.66 | 36% | 2.4 |
| | 13 | 13 | Compound (5) | 40 | 370.65 | 10 | 0.72 | 30% | 3.1 |
| | 14 | 14 | Compound (5) | 40 | 262.29 | 10 | 0.82 | 20% | 2.9 |
| | 15 | 15 | Compound (5) | 40 | 426.48 | 10 | 0.79 | 23% | 1.3 |
| | 16 | 16 | Compound (5) | 40 | 538.57 | 10 | 0.84 | 18% | 2.8 |
| | 17 | 17 | Compound (5) | 40 | 578.63 | 10 | 0.77 | 25% | 1.7 |
| | 18 | 18 | Compound (6) | 40 | 398.48 | 10 | 0.77 | 25% | 3.3 |
| | 19 | 19 | Compound (6) | 40 | 819.29 | 10 | 0.84 | 18% | 2.6 |
| | 20 | 23 | Compound (1) | 40 | 174.32 | 10 | 0.75 | 28% | 1.5 |
| | 21 | 24 | Compound (1) | 40 | 100.16 | 10 | 0.80 | 22% | 1.9 |
| | 22 | 25 | Compound (2) | 40 | 164.20 | 10 | 0.88 | 15% | 1.1 |
| Comparative | 1 | 20 | — | 40 | 118.09 | 10 | 1.17 | −14% | 1.2 |
| Example | 2 | 21 | — | 40 | 90.12 | 10 | 1.11 | −8% | 1.1 |
| | 3 | 22 | — | 40 | 134.18 | 10 | 1.18 | −15% | 1.2 |
| | 4 | — | — | 40 | — | 0 | 1.03 | — | 3.7 |

The details of the compound shown in Table 1 are as follows.

The compound 1 (corresponding to the compound (1)) is heptanal, which is represented by the general formula (1), in which R¹¹ and Xn represent single bonds, n₁₁ represents 0, and R¹² represents a hexyl group. The structural formula thereof is as follows.

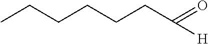

The compound 2 (corresponding to the compound (1)) is undecanal, which is represented by the general formula (1), in which R¹¹ and X₁₁ represent single bonds, n₁₁ represents 0, and R¹² represents a decyl group. The structural formula thereof is as follows.

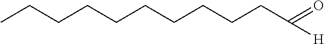

The compound 3 (corresponding to the compound (1)) is benzyloxyacetaldehyde, which is represented by the general formula (1), in which X₁₁ represents an oxygen atom, R¹¹ represents a methylene group, n₁₁ represents 0, and R¹² represents a benzyl group. The structural formula thereof is as follows.

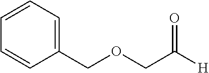

The compound 4 (corresponding to the compound (2)) is acetylacetone, which is represented by the general formula (2), in which R²¹ and X₂₁ represent single bonds, and R²² represents a methylene group. The structural formula thereof is as follows.

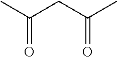

The compound 5 (corresponding to the compound (3)) is 1,3-dibromopropane, which is represented by the general formula (3), in which R³¹ represents a methylene group, and X₃₁ and X₃₂ represent bromine atoms. The structural formula thereof is as follows.

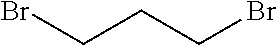

The compound 6 (corresponding to the compound (3)) is 1,4-dibromobutane, which is represented by the general formula (3), in which R³¹ represents a methylene group, and X₃₁ and X₃₂ represent bromine atoms. The structural formula thereof is as follows.

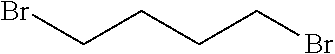

The compound 7 (corresponding to the compound (3)) is 1,6-dibromohexane, which is represented by the general formula (3), in which R³¹ represents a 1,4-butanediyl group, and X₃₁ and X₃₂ represent bromine atoms. The structural formula thereof is as follows.

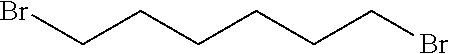

The compound 8 (corresponding to the compound (3)) is 1,10-dibromodecane, which is represented by the general formula (3), in which R³¹ represents a 1,8-octanediyl group, and X₃₁ and X₃₂ represent bromine atoms. The structural formula thereof is as follows.

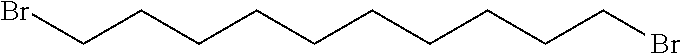

The compound 9 (corresponding to the compound (4)) is 1-dodecanethiol, which is represented by the general formula (4-1), in which R⁴¹¹ represents a single bond, n₄₁₁ represents 0, R⁴¹³ represents 1,12-dodecanediyl group, and X₄₁₁ represents a hydrogen atom. The structural formula thereof is as follows.

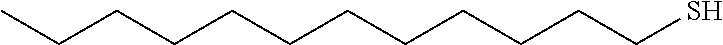

The compound 10 (corresponding to the compound (4)) is 1,10-decanedithiol, which is represented by the general formula (4-1), in which R⁴¹¹ represents a single bond, n₄₁₁ represents 0, R⁴¹³ represents 1,10-decanediyl group, and X₄₁₁ represents a thiol group. The structural formula thereof is as follows.

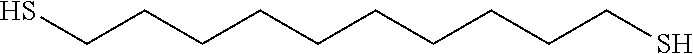

The compound 11 (corresponding to the compound (4)) is 3-mercaptopropyltrimethoxysilane, which is represented by the general formula (4-2), in which R⁴²¹ represents a 1,3-propanediyl group, R⁴²³ represents a methyl group, n₄₂₁ represents 0, and n₄₂₂ represents 3. The structural formula thereof is as follows.

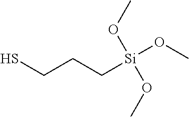

The compound 12 (corresponding to the compound (5)) is tri-n-octylphosphine oxide, which is represented by the general formula (5-1), in which R⁵¹¹, R⁵¹², and R⁵¹³ represent 1-octyl groups. The structural formula thereof is as follows.

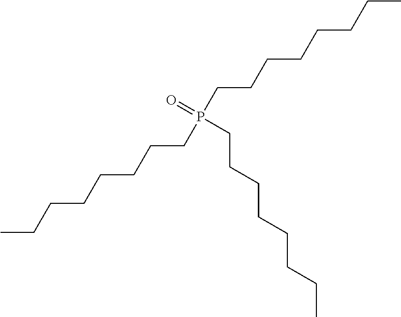

The compound 13 (corresponding to the compound (5)) is tri-n-octylphosphine, which is represented by the general formula (5-2), in which R⁵²¹, R⁵²², and R⁵²³ represent 1-octyl groups. The structural formula thereof is as follows.

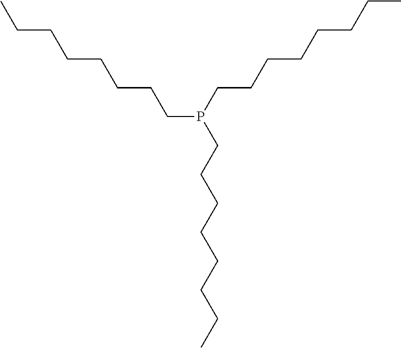

The compound 14 (corresponding to the compound (5)) is triphenylphosphine, which is represented by the general formula (5-2), in which R⁵²¹, R⁵²², and R⁵²³ represent phenyl groups. The structural formula thereof is as follows.

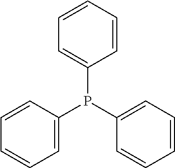

The compound 15 (corresponding to the compound (5)) is 1,4-bis(diphenylphosphino) butane, which is represented by the general formula (5-3), in which R⁵³¹, R⁵³², R⁵³⁵, and R⁵³⁶ represent phenyl groups, R⁵³³ represents a 1,4-butanediyl group, and R⁵³⁴ and X₅₃₁ represent single bonds. The structural formula thereof is as follows.

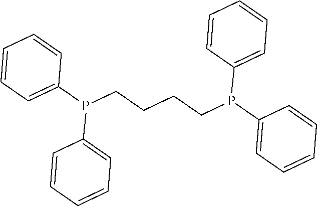

The compound 16 (corresponding to the compound (5)) is bis((2-diphenylphosphino)phenyl) ether, which is represented by the general formula (5-3), in which R⁵³¹, R⁵³², R⁵³⁵, and R⁵³⁶ represent phenyl groups, R⁵³³ and R⁵³⁴ represent benzenediyl groups, and X₅₃₁ represents an oxygen atom. The structural formula thereof is as follows.

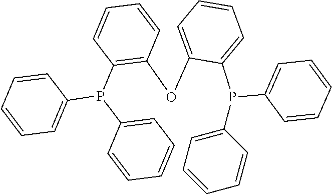

The compound 17 (corresponding to the compound (5)) is 4,5-bis(diphenylphosphino)-9,9-dimethylxanthene, which is represented by the general formula (5-3), in which R⁵³¹, R⁵³², R⁵³⁵, and R⁵³⁶ represent phenyl groups, R⁵³³ represents a xanthen-4,5-diyl group, and R⁵³⁴ and X₅₃₁ represent single bonds. The structural formula thereof is as follows.

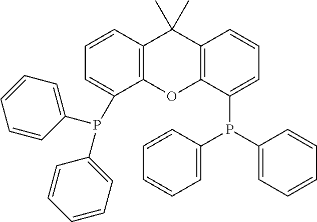

The compound 18 is tri-n-octyl borate, which is represented by the general formula (6), in which R⁶¹, R⁶², and R⁶³ represent octyloxy groups. The structural formula thereof is as follows.

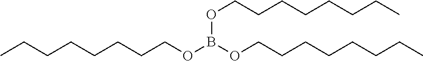

The compound 19 is tri-n-octadecyl borate, which is represented by the general formula (6), in which R⁶¹, R⁶², and R⁶³ represent octadecyloxy groups. The structural formula thereof is as follows.

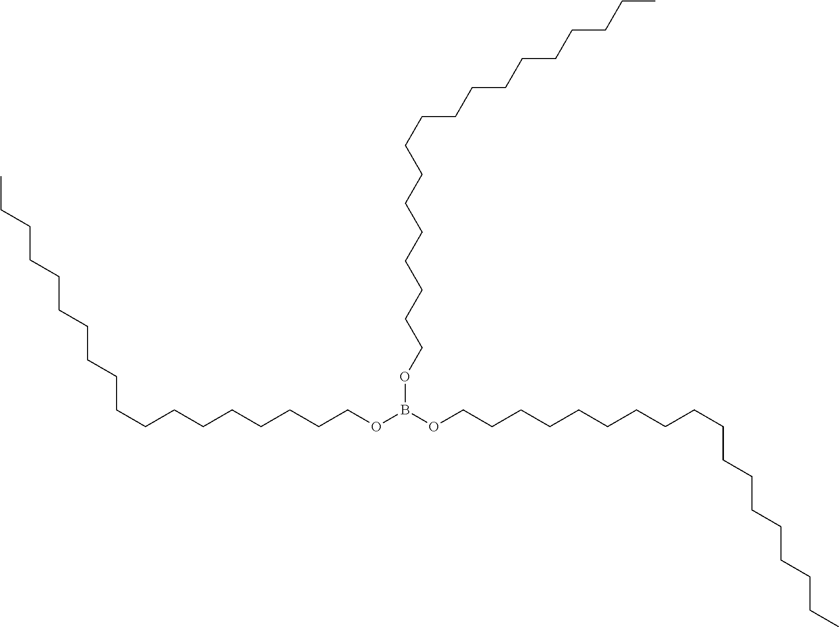

The compound 20 is dimethyl oxalate. The structural formula thereof is as follows.

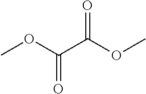

The compound 21 is 1,2-dimethoxyethane. The structural formula thereof is as follows.

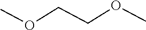

The compound 22 is dimethylene glycol dimethyl ether. The structural formula thereof is as follows.

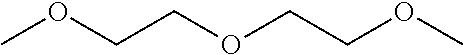

The compound 23 (corresponding to the compound (1)) is 2-((tert-butyldimethylsilyl)oxy) acetaldehyde, which is represented by the general formula (1), in which R¹¹ represents a methyl group, R¹² represents a tert-butyl group (1,1-dimethylethyl group), and X₁₁ represents a group represented by the general formula (1a), and in the general formula (1a), R^{11a} and R^{12a} represent methyl groups, and nu represents 0. The structural formula thereof is as follows.

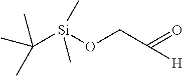

The compound 24 (corresponding to the compound (1)) is hexanal, which is represented by the general formula (1), in which R¹¹ and Xn represent single bonds, nu represents 0, and R¹² represents a pentyl group. The structural formula thereof is as follows.

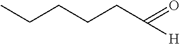

The compound 25 (corresponding to the compound (2)) is benzyloxyacetone (molecular weight: 164.20), which is represented by the general formula (2), in which X₂₁ represents an oxygen atom, R²¹ represents a methylene group, R²² represents a benzyl group, and n₂₁ represents 0. The structural formula thereof is as follows.

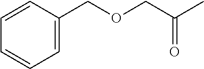

It has been confirmed by the examples that the modified sulfide solid electrolyte of the present embodiment has an oil absorption of 1.10 mL/g or less, i.e., a reduction rate of the oil absorption of 13% or more, and thus has a reduced oil absorption irrespective of the large specific surface area of 10 m²/g or more, resulting in the excellent coating suitability. It has also been confirmed that the ionic conductivity is 0.80 mS/cm or more. It has been understood that the presence of the compound (1) to (6) contained causes a tendency of decreasing the ionic conductivity by coating the surface thereof, but provides the excellent capabilities, i.e., the reduced oil absorption resulting in the excellent coating suitability, while suppressing the decrease of the ionic conductivity as much as possible, irrespective of the large specific surface area of 10 m²/g or more.

On the other hand, the sulfide solid electrolyte of Comparative Example 4, which is not mixed with the compounds (1) to (6) and does not contain the compounds, is the sulfide solid electrolyte produced in Production Example, which is the ordinary sulfide solid electrolyte. It has been confirmed that the sulfide solid electrolyte of Comparative Example 4 having a specific surface area of 40 m²/g has a large oil absorption of 0.99 mL/g and is deteriorated in coating suitability. Comparative Examples 1 to 3 using the compounds that do not correspond to the compound (1) to (6) provide a large oil absorption of approximately 1.1 to 1.2 mL/g, and fail to result in the reduction effect of the oil absorption that counterbalances the decrease of the ionic conductivity.

It has also been confirmed that the method of producing a modified sulfide solid electrolyte of the present embodiment is a production method favorable for exhibiting the effect of reducing the oil absorption and enhancing the coating suitability for the sulfide solid electrolyte having a large specific surface area of 10 m²/g or more.

### INDUSTRIAL APPLICABILITY

The modified sulfide solid electrolyte of the present embodiment is a sulfide solid electrolyte that is excellent in coating suitability in coating as a paste, and can exhibit the excellent battery capabilities efficiently, irrespective of the large specific surface area thereof. The modified sulfide solid electrolyte of the present embodiment has a high ionic conductivity, and therefore is favorably used in batteries, particularly batteries used in information-related devices, communication devices, and the like, such as personal computers, video cameras, and mobile phones.

1. A modified sulfide solid electrolyte comprising a sulfide solid electrolyte having a BET specific surface area of 10 m²/g or more and containing a lithium atom, a sulfur atom, a phosphorus atom, and a halogen atom, and at least one compound selected from the group consisting of compounds (1) to (6):
compound (1): a compound having a formyl group (CH(═O)—),
compound (2): a compound having one or more acetyl group (CH₃C(═O)—),
compound (3): a compound having two or more halogen-containing groups represented by —CH₂X, wherein X represents a fluorine atom or a bromine atom, and an organic group,
compound (4): a thiol compound,
compound (5): a metal-free phosphorus compound, provided that the compound does not contain an oxygen atom that is bonded to a phosphorus atom via a single bond, and
compound (6): a metal-free boron compound.

2. The modified sulfide solid electrolyte according to claim 1, comprising the compound (1), wherein the compound (1) is a compound represented by the following general formula (1): 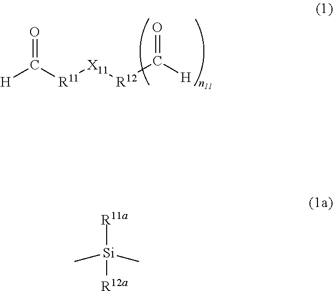
wherein in the general formula (1), R¹¹ and R¹² each independently represent an organic group or a single bond, X₁₁ represents an oxygen atom, a sulfur atom, a group represented by the general formula (1a), or a single bond, and nu represents 0 or 1, and in the general formula (1a), R^{11a} and R^{12a} each independently represent an organic group.

3. The modified sulfide solid electrolyte according to claim 1, comprising the compound (2), wherein the compound (2) is a compound represented by the following general formula (2): 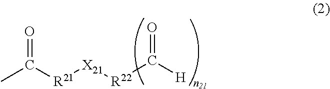
wherein in the general formula (2), R²¹ and R²² each independently represent an organic group or a single bond, X₂₁ represents an oxygen atom, a sulfur atom, or a single bond, and n₂₁ represents 0 or 1.

4. The modified sulfide solid electrolyte according to claim 1, comprising the compound (3), wherein the compound (3) is a compound represented by the following general formula (3): 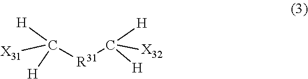
wherein in the general formula (3), R³¹ represents an organic group or a single bond, and X₃₁ and X₃₂ each independently represent a fluorine atom or a bromine atom.

5. The modified sulfide solid electrolyte according to claim 1, comprising the compound (4), wherein the compound (4) is at least one selected from the group consisting of a compound represented by the following general formula (4-1) and a compound represented by the following general formula (4-2): 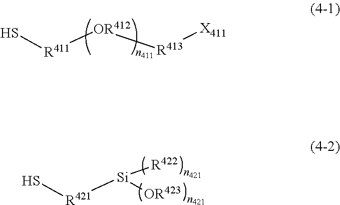
wherein in the general formula (4-1), R⁴¹¹, R⁴¹², and R⁴¹³ each independently represent an organic group or a single bond, X₄₁₁ represents a hydrogen atom or a thiol group, and n₄₁₁ represents an integer of 0 to 3, provided that at least one of R⁴¹¹, R⁴¹², and R⁴¹³ represents an organic group, and
in the general formula (4-2), R⁴²¹, R⁴²², and R⁴²³ each independently represent an organic group, n₄₂₁ and n₄₂₂ each represent an integer of 0 to 3, in which n₄₂₁ and n₄₂₂ satisfy n₄₂₁+n₄₂₂=3.

6. The modified sulfide solid electrolyte according to claim 1, comprising the compound (5), wherein the compound (5) is at least one selected from the group consisting of a compound represented by the following general formula (5-1), a compound represented by the following general formula (5-2), and a compound represented by the following general formula (5-3): 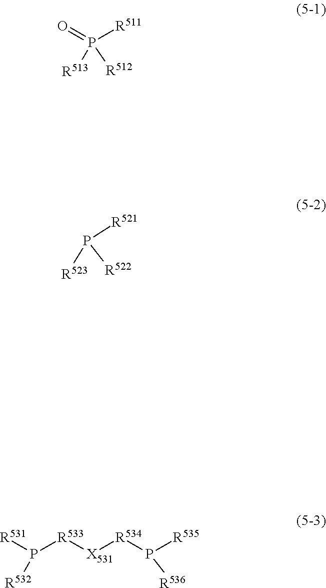
wherein in the general formula (5-1), R⁵¹¹, R⁵¹², and R⁵¹³ each independently represent an organic group, in the general formula (5-2), R⁵²¹, R⁵²², and R⁵²³ each independently represent an organic group, and in the general formula (5-3), R⁵³¹, R⁵³², R⁵³⁵, and R⁵³⁶ each independently represent an organic group, R⁵³³ and R⁵³⁴ each independently represent a single bond or an organic group, and X₅₃₁ represents a single bond or an oxygen atom, in which at least one of R⁵³³ and R⁵³⁴ represents an organic group, and R⁵³³ and R⁵³⁴ may be bonded to each other to form a condensed ring.

7. The modified sulfide solid electrolyte according to claim 1, comprising the compound (5), wherein the compound (5) has a molecular weight of 3,000 or less.

8. The modified sulfide solid electrolyte according to claim 1, comprising the compound (6), wherein the compound (6) is a compound represented by the following general formula (6): 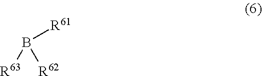
wherein in the general formula (6), R⁶¹, R⁶², and R⁶³ each independently represent an organic group.

9. The modified sulfide solid electrolyte according to claim 1, wherein the modified sulfide solid electrolyte has a content of the compound of 0.03 part by mass or more and 25 parts by mass or less per 100 parts by mass of the sulfide solid electrolyte.

10. A method of producing a modified sulfide solid electrolyte comprising:
mixing a sulfide solid electrolyte having a BET specific surface area of 10 m²/g or more and containing a lithium atom, a sulfur atom, a phosphorus atom, and a halogen atom, at least one selected from the group consisting of compounds (1) to (6), and an organic solvent, and
removing the organic solvent:
compound (1): a compound having a formyl group (CH(═O)—),
compound (2): a compound having one or more acetyl group (CH₃C(═O)—),
compound (3): a compound having two or more halogen-containing groups represented by —CH₂X, wherein X represents a fluorine atom or a bromine atom, and an organic group,
compound (4): a thiol compound,
compound (5): a metal-free phosphorus compound, and
compound (6): a metal-free boron compound.

11. The method of producing a modified sulfide solid electrolyte according to claim 10, wherein the organic solvent is at least one selected from the group consisting of an aliphatic hydrocarbon solvent, an alicyclic hydrocarbon solvent, an aromatic hydrocarbon solvent, an ether solvent, an ester solvent, and a nitrile solvent.

12. An electrode mixture comprising the modified sulfide solid electrolyte according to claim 1, and an electrode active substance.

13. A lithium ion battery comprising the modified sulfide solid electrolyte according to claim 1.

14. A lithium ion battery comprising the electrode mixture according to claim 12.
